(19) United States
(12) Patent Application Publication
(10) Pub. No.: US 2026/0353122 A1
(43) Pub. Date: Nov. 5, 2026

(54) METHOD AND APPARATUS FOR INFORMATION TRANSMISSION

(71) Applicant: Beijing Xiaomi Mobile Software Co., Ltd., Beijing (CN)

(72) Inventor: Xiaolong LI, Beijing (CN)

(73) Assignee: Beijing Xiaomi Mobile Software Co., Ltd., Beijing (CN)

(21) Appl. No.: 19/125,582

(22) PCT Filed: Nov. 3, 2022
(86) PCT No.: PCT/CN2022/129580

§ 371 Date: Apr. 29, 2025

(51) Int. Cl. H04W 24/08; H04W 24/10

(52) U.S. Cl. CPC H04W 24/08; H04W 24/10

(57) ABSTRACT

A method for transmitting information, including: sending indication information, wherein the indication information is used for indicating whether a base station supports receiving a first request message sent by a terminal, and the first request message is used for requesting the base station to activate or deactivate a preconfigured measurement gap.

### CROSS-REFERENCE

The present application is a U.S. National Stage of International Application No. PCT/CN2022/129580, filed on Nov. 3, 2022, the contents of all of which are incorporated herein by reference in their entireties for all purposes.

### BACKGROUND OF THE INVENTION

In Release 17 (R17), a preconfigured measurement gap (MG) for location is introduced to reduce a location delay. The MG can be pre-configured for a terminal and then activated by a base station as needed.

There are two solutions for how to request the base station to activate the preconfigured MG configured for the terminal:
the first solution is to activate the MG by a location management function (LMF) request; and
the second solution is to activate the MG by a request from the terminal itself.

### SUMMARY OF THE INVENTION

In a first aspect, a method for transmitting information is provided in the embodiments of the present disclosure. The method is performed by a base station and includes:
transmitting indication information, where the indication information is used for indicating whether the base station supports reception of a first request message transmitted by a terminal, and the first request message is used for requesting the base station to activate or deactivate a preconfigured measurement gap.

In a second aspect, a method for transmitting information is provided in the embodiments of the present disclosure. The method is performed by a terminal and includes:
receiving indication information transmitted by a base station, where the indication information is used for indicating whether the base station supports reception of a first request message transmitted by the terminal, and the first request message is used for requesting the base station to activate or deactivate a preconfigured measurement gap.

In a third aspect, a method for transmitting information is provided in the embodiments of the present disclosure. The method is performed by a location management function (LMF) and includes:
receiving indication information transmitted by a base station, where the indication information is used for indicating whether the base station supports reception of a first request message transmitted by a terminal, and the first request message is used for requesting the base station to activate or deactivate a preconfigured measurement gap.

In a fourth aspect, an apparatus for transmitting information is provided in the embodiments of the present disclosure. The apparatus includes:
one or more processors, and
a memory for storing processor-executable instructions, where
the one or more processors are configured to perform any one of the methods for transmitting information on a base station side.

In a fifth aspect, an apparatus for transmitting information is provided in the embodiments of the present disclosure. The apparatus includes:
one or more processors, and
a memory for storing processor-executable instructions, where
the one or more processors are configured to perform any one of the methods for transmitting information on a terminal side.

In a sixth aspect, an apparatus for transmitting information is provided in the embodiments of the present disclosure. The apparatus includes:
one or more processors, and
a memory for storing processor-executable instructions, where
the one or more processors are configured to perform any one of the methods for transmitting information on an LMF side.

It should be understood that both the foregoing general description and the following detailed description are illustrative and interpretative merely and do not limit the present disclosure.

### BRIEF DESCRIPTION OF DRAWINGS

The accompanying drawings here are incorporated into the description as a constituent part of the description, illustrate embodiments conforming to the present disclosure, and serve to explain the principles of the present disclosure along with the description.

FIG. 1 is a schematic flowchart of a method for configuring a preconfigured measurement gap according to an example;

FIG. 2 is a schematic flowchart of a method for transmitting information according to an example;

FIG. 3 is a schematic flowchart of another method for transmitting information according to an example;

FIG. 4 is a schematic flowchart of yet another method for transmitting information according to an example;

FIG. 5 is a schematic flowchart of yet another method for transmitting information according to an example;

FIG. 6 is a schematic flowchart of yet another method for transmitting information according to an example;

FIG. 7 is a schematic flowchart of yet another method for transmitting information according to an example;

FIG. 8 is a schematic flowchart of yet another method for transmitting information according to an example;

FIG. 9 is a schematic flowchart of yet another method for transmitting information according to an example;

FIG. 10 is a schematic flowchart of yet another method for transmitting information according to an example;

FIG. 11 is a schematic flowchart of yet another method for transmitting information according to an example;

FIG. 12 is a schematic flowchart of still another method for transmitting information according to an example;

FIG. 13 is a block diagram of an apparatus for transmitting information according to an example;

FIG. 14 is a block diagram of another apparatus for transmitting information according to an example;

FIG. 15 is a block diagram of yet another apparatus for transmitting information according to an example;

FIG. 16 is a block diagram of a system for transmitting information according to an example;

FIG. 17 is a schematic structural diagram of an apparatus for transmitting information according to an example of the present disclosure;

FIG. 18 is a schematic structural diagram of another apparatus for transmitting information according to an example of the present disclosure; and

FIG. 19 is a schematic structural diagram of yet another apparatus for transmitting information according to an example of the present disclosure.

### DETAILED DESCRIPTION OF THE INVENTION

Description will be made in detail to examples here, and their instances are illustrated in the accompanying drawings. When the following description relates to the accompanying drawings, the same numbers in different accompanying drawings denote the same or similar elements, unless indicated otherwise. The implementations described in the following examples do not denote all implementations consistent with the present disclosure. On the contrary, the embodiments are merely instances of apparatuses and methods consistent with some aspects of the present disclosure, as recited in the appended claims.

The terms used in the present disclosure are merely to describe the specific embodiments, instead of limiting the present disclosure. The singular forms such as “a”, “an”, “the”, and “this” used in the present disclosure and the appended claims are also intended to include the plural forms unless clearly stated otherwise in the context. It should also be understood that the term “and/or” used here indicates and encompasses any or all possible combinations of at least one associated item listed.

It should be understood that although the terms “first”, “second”, “third”, etc. may be employed in the present disclosure to describe various information, such information should not be limited to these terms. These terms are used only to distinguish information of the same type from each other. For example, the first information may also be referred to as the second information, and similarly, the second information may also be referred to as the first information, without departing from the scope of the present disclosure. The word “if” as used here, may be interpreted as “at the time of”, “when” or “in response to a determination” depending on the context.

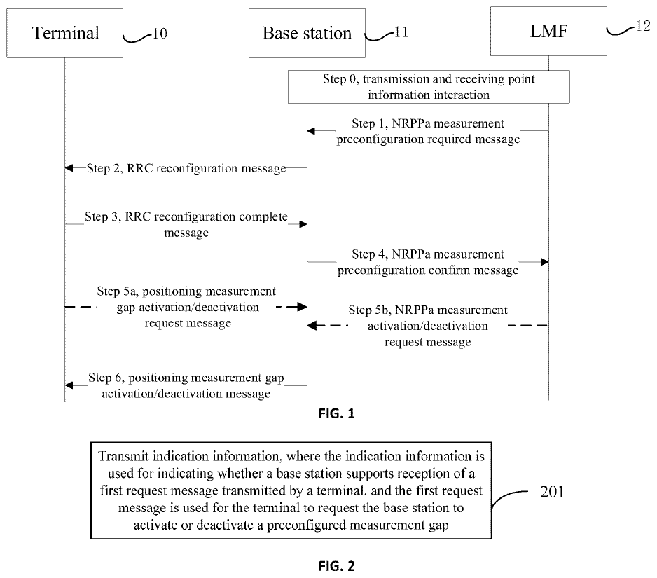

In R17, reference may be made to FIG. 1 for a process of configuring a preconfigured measurement gap for a terminal 10 by a base station 11. The process includes steps 0-6.

Step 0: Transmission and receiving point (TRP) information interaction is performed between the base station 11 and an LMF 12.

Step 1, the LMF 12 transmits a new radio positioning protocol a measurement preconfiguration required (NRPPa measurement preconfiguration required) message to the base station 11 and requests the base station 11 to configure the preconfigured measurement gap for the terminal 10.

Step 2, after receiving the request message, the base station 11 transmits the preconfigured measurement gap to the terminal 10 via a radio resource control (RRC) message.

The RRC message may be an RRC reconfiguration message.

Step 3, the terminal 10 feeds back an RRC reconfiguration complete message to the base station 11.

Step 4, the base station 11 transmits an NRPPa measurement preconfiguration confirm message to the LMF 12.

Step 5a, the terminal 10 transmits a positioning measurement gap activation/deactivation request message to the base station 11.

Step 5b: the LMF 12 transmits an NRPPa measurement activation/deactivation request message to the base station 11.

Either step 5a or step 5b is performed. That is, the base station 11 may be requested by the terminal 10 or the LMF 12 to activate or deactivate the preconfigured measurement gap.

Step 6, the base station 11 transmits the positioning measurement gap activation/deactivation message to the terminal 10.

It can be seen that both the terminal and the LMF can request the base station to activate (or deactivate) the preconfigured measurement gap, and then the base station transmits an activation (or deactivation) message to the terminal to activate (or deactivate) the preconfigured measurement gap.

Since there are two solutions of requesting the base station to activate the preconfigured measurement gap, and the base station may support the terminal in requesting activation or deactivation of the preconfigured measurement gap, in a case where the base station does not support the terminal in requesting the activation of the preconfigured measurement gap, the following problems exist:

Problem 1: The terminal is uninformed that the base station does not support the terminal in requesting the activation of the preconfigured measurement gap, such that the base station cannot activate the preconfigured measurement gap after the terminal transmits a request message for requesting the activation of the preconfigured measurement gap to the base station.

Problem 2: The LMF is uninformed that the base station does not support the terminal in requesting the activation of the preconfigured measurement gap, such that the LMF may determine that the terminal transmits the request message to the base station to request the activation of the preconfigured measurement gap, and thus the LMF does not transmit the request message to the base station to request the activation of the preconfigured measurement gap. This may result in that the LMF does not request the activation of the preconfigured measurement gap again under the condition that the UE does not request the activation of the preconfigured measurement gap.

The above situations may cause the preconfigured measurement gap (MG) to fail to be activated.

In order to solve the above technical problems, the present disclosure provides the following method and apparatus for transmitting information, and the storage medium, relating to the field of communication, so as to guarantee the activation or deactivation of the preconfigured measurement gap, thus improving accuracy and reliability of terminal positioning, and reducing a location delay.

The method for transmitting information provided in the present disclosure is first introduced from a base station side.

Embodiments of the present disclosure provide a method for transmitting information. With reference to FIG. 2, FIG. 2 is a flowchart of a method for transmitting information according to an embodiment. The method may be performed by a base station and may include step 201.

Step 201: the base station transmits indication information, where the indication information is used for indicating whether the base station supports reception of a first request message transmitted by a terminal, and the first request message is used for requesting the base station to activate or deactivate a preconfigured measurement gap.

In the embodiment of the present disclosure, the base station may transmit the indication information to an opposite device. The opposite device is informed through the indication information of whether the base station supports reception of the first request message transmitted by the terminal. The first request message is used for requesting the base station to activate or deactivate the preconfigured measurement gap. It should be noted that the first request message is transmitted by the terminal to the base station.

In a possible implementation, the opposite device may be a terminal. Accordingly, the base station may transmit the indication information to the terminal to inform the terminal of whether the base station supports reception of the first request message transmitted by the terminal. The first request message is used for requesting the base station to activate or deactivate the preconfigured measurement gap. The terminal may determine whether activation or deactivation of the preconfigured measurement gap is requested by the terminal according to the indication information.

In another possible implementation, the opposite device may be a core network device, for example, LMF. Accordingly, the base station may transmit the indication information to the LMF to inform the LMF of whether the base station supports reception of the first request message transmitted by the terminal. The first request message is used for requesting the base station to activate or deactivate the preconfigured measurement gap. The LMF may determine whether activation or deactivation of the preconfigured measurement gap is requested by the LMF according to the indication information.

In the embodiment of the present disclosure, the base station receives the first request message from the terminal. The first request message is used for requesting the base station to activate or deactivate the preconfigured measurement gap. That is, the terminal requests the base station to activate or deactivate the preconfigured measurement gap via the first request message. Alternatively, the base station may receive a third request message from the LMF. The third request message is used for requesting the base station to activate or deactivate the preconfigured measurement gap. That is, the LMF requests the base station to activate or deactivate the preconfigured measurement gap via the third request message. After receiving the first request message or the third request message, the base station may transmit an activation message or a deactivation message to the terminal, so as to activate or deactivate the preconfigured measurement gap.

In a possible implementation, the base station may transmit the activation message or the deactivation message to the terminal through a downlink media access control element (DL MAC CE).

It should be noted that in the present disclosure, the third request message and the first request message have similar functions. Both of them are used for requesting the base station to activate or deactivate the preconfigured measurement gap. A difference lies in that the third request message is transmitted to the base station by the LMF, and the first request message is transmitted to the base station by the terminal. Moreover, a message format and content of the third request message are different from those of the first request message.

In a possible implementation, the indication information may be used for indicating at least one of the following: the base station supports the terminal in transmitting the first request message; the base station allows the terminal to transmit the first request message; the base station does not support the terminal in transmitting the first request message; or the base station does not allow the terminal to transmit the first request message.

In an instance, the indication information may be used for indicating that the base station supports the terminal in transmitting the first request message. That is, the base station has a capability to support the terminal in requesting activation or deactivation of the preconfigured measurement gap.

In another instance, the indication information may be used for indicating that the base station allows the terminal to transmit the first request message. That is, the base station has a capability to support the terminal in requesting activation or deactivation of the preconfigured measurement gap. The base station currently allows the terminal to transmit the first request message to the base station.

In another instance, the indication information may be used for indicating that the base station does not support the terminal in transmitting the first request message. That is, the base station does not have the capability to support the terminal in requesting activation or deactivation of the preconfigured measurement gap.

In another instance, the indication information may be used for indicating that the base station does not allow the terminal to transmit the first request message. In this case, the terminal may determine that the base station temporarily or permanently does not allow the terminal to transmit the first request message according to the indication information.

In another example, the indication information may be used for indicating that the base station supports the terminal in transmitting the first request message, and that the base station allows the terminal to transmit the first request message. That is, the base station has the capability to support the terminal in requesting the activation or deactivation of the preconfigured measurement gap. Moreover, the base station allows the terminal to transmit the first request message on the basis of loads, service demands, etc.

Alternatively, the indication information may be used for indicating that the base station supports the terminal in transmitting the first request message, and that the base station does not allow the terminal to transmit the first request message. That is, the base station has the capability to support the terminal in requesting the activation or deactivation of the preconfigured measurement gap. Moreover, the base station temporarily does not allow the terminal to transmit the first request message on the basis of loads, service demands, etc.

The above are merely illustrative descriptions. In practical application, the solutions in which the indication information is used for indicating whether the base station has the capability to support the terminal in requesting the activation or deactivation of the preconfigured measurement gap should all fall within a protection scope of the present disclosure.

In a possible implementation, the preconfigured measurement gap is at least used for the terminal to perform positioning-related measurement.

Certainly, the preconfigured measurement gap may also be used for the terminal to perform radio resource management (RRM), etc., which is not limited in the present disclosure. In the example, the indication information may be transmitted by the base station. The indication information is used for indicating whether the base station supports reception of the first request message transmitted by the terminal. The first request message is used for requesting the base station to activate or deactivate the preconfigured measurement gap, that is, the base station may inform an opposite device of whether the base station supports the terminal in requesting the activation or deactivation of the preconfigured measurement gap. Thus the activation or deactivation of a preconfigured measurement gap may be guaranteed, accuracy and reliability of terminal positioning are improved, and a location delay is reduced.

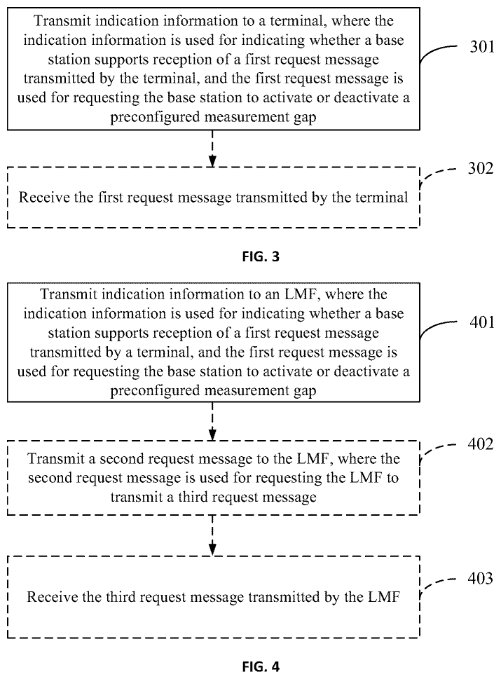

In some optional embodiments, the embodiments of the present disclosure provide a method for transmitting information. With reference to FIG. 3, FIG. 3 is a flowchart of a method for transmitting information according to an embodiment. The method may be performed by a base station and may include steps 301 and 302.

Step 301: the base station transmits indication information to a terminal, where the indication information is used for indicating whether the base station supports reception of a first request message transmitted by the terminal, and the first request message is used for requesting the base station to activate or deactivate a preconfigured measurement gap.

In the embodiment of the present disclosure, the base station may transmit the indication information to the terminal, so as to inform the terminal of whether the base station supports reception of the first request message transmitted by the terminal. The first request message is used for requesting the base station to activate or deactivate the preconfigured measurement gap. That is, the base station may inform the terminal through the indication information of whether the base station supports the terminal in requesting activation or deactivation of the preconfigured measurement gap from the base station. The terminal may determine whether activation or deactivation of the preconfigured measurement gap is requested by the terminal itself according to the indication information.

In a possible implementation, in a case where the preconfigured measurement gap is configured for the terminal, the base station transmits the indication information to the terminal. Alternatively, the base station may transmit the indication information to the terminal in a case of configuring the preconfigured measurement gap for the terminal. The indication information may be transmitted separately, together with the preconfigured measurement gap, or within a specified time range in which the preconfigured measurement gap is configured, which is not limited in the present disclosure.

In a possible implementation, the indication information may be used for indicating at least one of the following: the base station supports the terminal in transmitting the first request message; the base station allows the terminal to transmit the first request message; the base station does not support the terminal in transmitting the first request message; or the base station does not allow the terminal to transmit the first request message.

In an instance, the indication information may be used for indicating that the base station supports the terminal in transmitting the first request message. That is, the base station has a capability to support the terminal in requesting activation or deactivation of the preconfigured measurement gap.

In another instance, the indication information may be used for indicating that the base station allows the terminal to transmit the first request message. That is, the base station has a capability to support the terminal in requesting activation or deactivation of the preconfigured measurement gap. The base station currently allows the terminal to transmit the first request message to the base station.

In another instance, the indication information may be used for indicating that the base station does not support the terminal in transmitting the first request message. That is, the base station does not have the capability to support the terminal in requesting activation or deactivation of the preconfigured measurement gap.

In another instance, the indication information may be used for indicating that the base station does not allow the terminal to transmit the first request message. In this case, the terminal may determine that the base station temporarily or permanently does not allow the terminal to transmit the first request message according to the indication information.

In another example, the indication information may be used for indicating that the base station supports the terminal in transmitting the first request message, and that the base station allows the terminal to transmit the first request message. That is, the base station has the capability to support the terminal in requesting the activation or deactivation of the preconfigured measurement gap. Moreover, the base station allows the terminal to transmit the first request message on the basis of loads, service demands, etc.

Alternatively, the indication information may be used for indicating that the base station supports the terminal in transmitting the first request message, and that the base station does not allow the terminal to transmit the first request message. That is, the base station has the capability to support the terminal in requesting the activation or deactivation of the preconfigured measurement gap. Moreover, the base station temporarily does not allow the terminal to transmit the first request message on the basis of loads, service demands, etc.

The above are merely illustrative descriptions. In practical application, the solutions in which the indication information is used for indicating whether the base station has the capability to support the terminal in requesting the activation or deactivation of the preconfigured measurement gap should all fall within a protection scope of the present disclosure.

In a possible implementation, the preconfigured measurement gap is at least used for the terminal to perform positioning-related measurement.

Certainly, the preconfigured measurement gap may also be used for the terminal to perform RRM, etc., which is not limited in the present disclosure.

Step 302: the base station receives the first request message transmitted by the terminal.

In the embodiment of the present disclosure, step 302 is an optional step.

In a case where the indication information indicates that the base station supports reception of the first request message transmitted by the terminal, and the terminal determines to request the activation or deactivation of the preconfigured measurement gap by itself, step 302 may be performed. In this case, the base station may receive the first request message transmitted by the terminal.

In an instance, the indication information indicates that the base station supports the terminal in transmitting the first request message. The terminal may determine whether to request the activation or deactivation of the preconfigured measurement gap by itself according to the indication information. Further, step 302 may be performed. The base station receives the first request message transmitted by the terminal.

Certainly, step 302 may not be performed in this case. That is, the base station may receive a third request message transmitted by a core network device, for example, an LMF. The third request message is used for requesting the base station to activate or deactivate the preconfigured measurement gap.

After receiving the first request message from the terminal or the third request message from the LMF, the base station may transmit an activation message or a deactivation message to the terminal, so as to activate or deactivate the preconfigured measurement gap.

The base station may transmit the activation message or the deactivation message to the terminal via DL MAC CE.

In another instance, the indication information indicates that the base station allows the terminal to transmit the first request message. The terminal may determine whether to request the activation or deactivation of the preconfigured measurement gap by itself according to the indication information. Further, step 302 may be performed. The base station receives the first request message transmitted by the terminal.

Certainly, step 302 may not be performed in this case. That is, the base station may receive a third request message transmitted by an LMF. The third request message is used for requesting the base station to activate or deactivate the preconfigured measurement gap. The third request message is transmitted by a core network device, for example, the LMF, to the base station.

After receiving the first request message from the terminal or the third request message from the LMF, the base station may transmit an activation message or a deactivation message to the terminal, so as to activate or deactivate the preconfigured measurement gap.

The base station may transmit the activation message or the deactivation message to the terminal via DL MAC CE.

In another instance, in a case where the indication information indicates that the base station does not support the terminal in transmitting the first request message, step 302 may not be performed. That is, the base station does not receive the first request message transmitted by the terminal. Under the condition that the base station does not support the terminal in transmitting the first request message, signaling resource waste caused by the terminal still transmitting the first request message to the base station is avoided.

Alternatively, step 302 may still be performed. That is, the base station receives the first request message transmitted by the terminal, but the base station cannot activate or deactivate the preconfigured measurement gap based on the first request message.

Moreover, the base station may receive a third request message transmitted by an LMF. The third request message is used for requesting the base station to activate or deactivate the preconfigured measurement gap. After receiving the third request message from the LMF, the base station may transmit an activation message or a deactivation message to the terminal, so as to activate or deactivate the preconfigured measurement gap. The base station may transmit the activation message or the deactivation message to the terminal via DL MAC CE. The activation or deactivation of a preconfigured measurement gap may be guaranteed, such that the accuracy and reliability of terminal positioning is improved, and a location delay is reduced.

In another instance, in a case where the indication information indicates that the base station does not allow the terminal to transmit the first request message, step 302 cannot be performed. That is, the base station does not receive the first request message transmitted by the terminal. Signaling resource waste caused by the terminal still transmitting the first request message to the base station is avoided.

Moreover, the base station may receive a third request message transmitted by an LMF. The third request message is used for requesting the base station to activate or deactivate the preconfigured measurement gap. After receiving the third request message from the LMF, the base station may transmit an activation message or a deactivation message to the terminal, so as to activate or deactivate the preconfigured measurement gap. The base station may transmit the activation message or the deactivation message to the terminal via DL MAC CE. The activation or deactivation of a preconfigured measurement gap may be guaranteed, such that the accuracy and reliability of terminal positioning is improved, and a location delay is reduced.

In another instance, the indication information indicates that the base station supports the terminal in transmitting the first request message, and that the base station allows the terminal to transmit the first request message. The terminal may determine whether to request the activation or deactivation of the preconfigured measurement gap by itself according to the indication information. Further, step 302 may be performed. The base station receives the first request message transmitted by the terminal.

Certainly, step 302 may not be performed in this case. That is, the base station may receive a third request message transmitted by an LMF. The third request message is used for the base station to activate or deactivate the preconfigured measurement gap.

After receiving the first request message from the terminal or the third request message from the LMF, the base station may transmit an activation message or a deactivation message to the terminal, so as to activate or deactivate the preconfigured measurement gap.

The base station may transmit the activation message or the deactivation message to the terminal via DL MAC CE.

In another instance, in a case where the indication information indicates that the base station supports the terminal in transmitting the first request message, and that the base station does not allow the terminal to transmit the first request message, step 302 cannot be performed. That is, the base station does not receive the first request message transmitted by the terminal. Signaling resource waste caused by the terminal still transmitting the first request message to the base station is avoided.

Moreover, the base station may receive a third request message transmitted by an LMF. The third request message is used for requesting the base station to activate or deactivate the preconfigured measurement gap. After receiving the third request message from the LMF, the base station may transmit an activation message or a deactivation message to the terminal, so as to activate or deactivate the preconfigured measurement gap. The base station may transmit the activation message or the deactivation message to the terminal via DL MAC CE. The activation or deactivation of a preconfigured measurement gap may be guaranteed, such that the accuracy and reliability of terminal positioning is improved, and a location delay is reduced. In a possible implementation, the base station may receive the first request message transmitted by the terminal via a first message. The first message may be an uplink media access control element (UL MAC CE).

In the embodiment, the base station may inform the terminal of whether the base station supports the terminal in requesting the activation or deactivation of the preconfigured measurement gap. The activation or deactivation of the preconfigured measurement gap may be guaranteed, accuracy and reliability of terminal positioning are improved, and a location delay is reduced.

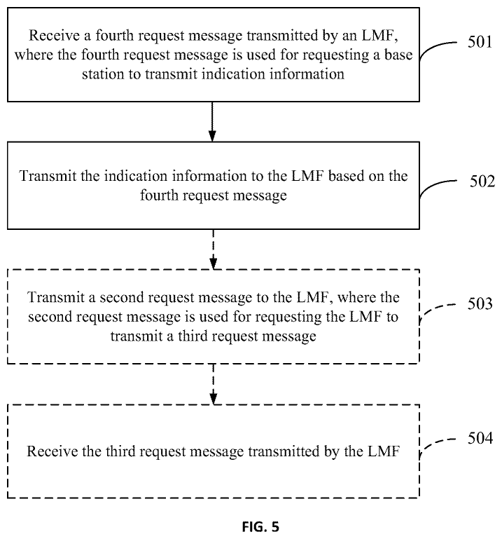

In some embodiments, the embodiments of the present disclosure provide a method for transmitting information. With reference to FIG. 4, FIG. 4 is a flowchart of a method for transmitting information according to an embodiment. The method may be performed by a base station and may include steps 401-403.

Step 401: the base station transmits indication information to an LMF, where the indication information is used for indicating whether the base station supports reception of a first request message transmitted by a terminal, and the first request message is used for requesting the base station to activate or deactivate a preconfigured measurement gap.

In the embodiment of the present disclosure, the base station may transmit the indication information to a core network device, for example, the LMF to inform the LMF of whether the base station supports reception of the first request message transmitted by the terminal. The first request message is used for requesting the base station to activate or deactivate the preconfigured measurement gap. The LMF may determine whether activation or deactivation of the preconfigured measurement gap is requested by the LMF according to the indication information.

In a possible implementation, the base station may transmit the indication information to the LMF via a first NRPPa message.

In an instance, the first NRPPa message may be any of the following: a measurement preconfiguration confirm message; a transmission and receiving point information response (TRP information response) message; or other NRPPa messages.

The other NRPPa messages here are NRPPa messages other than the measurement preconfiguration confirm message and the transmission and receiving point information response message.

In an instance, the indication information may be used for indicating that the base station supports the terminal in transmitting the first request message. That is, the base station has a capability to support the terminal in requesting activation or deactivation of the preconfigured measurement gap.

In another instance, the indication information may be used for indicating that the base station allows the terminal to transmit the first request message. That is, the base station has a capability to support the terminal in requesting activation or deactivation of the preconfigured measurement gap. The base station currently allows the terminal to transmit the first request message to the base station.

In another instance, the indication information may be used for indicating that the base station does not support the terminal in transmitting the first request message. That is, the base station does not have the capability to support the terminal in requesting activation or deactivation of the preconfigured measurement gap.

In another instance, the indication information may be used for indicating that the base station does not allow the terminal to transmit the first request message. In this case, the terminal may determine that the base station temporarily or permanently does not allow the terminal to transmit the first request message according to the indication information.

In another example, the indication information may be used for indicating that the base station supports the terminal in transmitting the first request message, and that the base station allows the terminal to transmit the first request message. That is, the base station has the capability to support the terminal in requesting the activation or deactivation of the preconfigured measurement gap. Moreover, the base station allows the terminal to transmit the first request message on the basis of loads, service demands, etc.

Alternatively, the indication information may be used for indicating that the base station supports the terminal in transmitting the first request message, and that the base station does not allow the terminal to transmit the first request message. That is, the base station has the capability to support the terminal in requesting the activation or deactivation of the preconfigured measurement gap. Moreover, the base station temporarily does not allow the terminal to transmit the first request message on the basis of loads, service demands, etc.

The above are merely illustrative descriptions. In practical application, the solutions in which the indication information is used for indicating whether the base station has the capability to support the terminal in requesting the activation or deactivation of the preconfigured measurement gap should all fall within a protection scope of the present disclosure.

In a possible implementation, the preconfigured measurement gap is at least used for the terminal to perform positioning-related measurement.

Certainly, the preconfigured measurement gap may also be used for the terminal to perform RRM, etc., which is not limited in the present disclosure.

Step 402: the base station transmits a second request message to the LMF, where the second request message is used for requesting the LMF to transmit a third request message.

Specifically, the base station may transmit the second request message to a core network device, for example, the LMF. In response to receiving the second request message, the LMF may transmit the third request message to the base station.

In the embodiment of the present disclosure, step 402 may be performed alternatively.

In a possible implementation, in a case where the indication information indicates that the base station does not support and/or does not allow the terminal to request the activation or deactivation of the preconfigured measurement gap, step 402 may be performed. The base station transmits the second request message to the LMF to request the LMF to transmit the third request message to the base station, so as to request the base station to activate or deactivate the preconfigured measurement gap.

In another possible implementation, in a case where the indication information indicates that the base station supports and/or allows the terminal to request the activation or deactivation of the preconfigured measurement gap, step 402 may not be performed. That is, the terminal may transmit the first request message to the base station. The first request message is used for requesting the base station to activate or deactivate the preconfigured measurement gap.

In another possible implementation, in a case where the indication information indicates that the base station supports and/or allows the terminal to request the activation or deactivation of the preconfigured measurement gap, step 402 may be performed. That is, in this case, the base station may transmit the second request message to the LMF to request the LMF to transmit the third request message to the base station. The third request message is used for requesting the base station to activate or deactivate the preconfigured measurement gap. Accordingly, the terminal may not transmit the first request message to the base station anymore.

In another possible implementation, regardless of a content of the indication information, step 402 may be performed. That is, the base station does not support or allow the terminal in requesting or to request the activation or deactivation of the preconfigured measurement gap by default. In this case, the base station may transmit the second request message to the LMF to request the LMF to transmit the third request message to the base station. The third request message is used for requesting the base station to activate or deactivate the preconfigured measurement gap. Accordingly, the terminal may not transmit the first request message to the base station anymore.

In another possible implementation, step 402 may be directly performed without performing step 401. Accordingly, subsequent step 403 may be directly performed. That is, the LMF directly transmits the third request message to the base station according to the second request message. The third request message is used for requesting the base station to activate or deactivate the preconfigured measurement gap. The base station replaces the indication information with the second request message. Under the condition of receiving the second request message, the LMF may determine that the base station does not support or allow the terminal in transmitting/to transmit the first request message. Thus the LMF may transmit the third request message to the base station according to the second request message.

It should be noted that the third request message and the first request message have similar functions. Both of them are used for requesting the base station to activate or deactivate the preconfigured measurement gap. A difference lies in that the third request message is transmitted to the base station by the LMF, and the first request message is transmitted to the base station by the terminal. Moreover, a message format and content of the third request message are different from those of the first request message.

In a possible implementation, the base station may transmit the second request message to the LMF via a first NRPPa message.

In an instance, the first NRPPa message may be any of the following: a measurement preconfiguration confirm message; a transmission and receiving point information response (TRP information response) message; or other NRPPa messages.

The other NRPPa messages here are NRPPa messages other than the measurement preconfiguration confirm message and the transmission and receiving point information response message.

That is, the base station may transmit the indication information together with the second request message to the LMF via the first NRPPa message.

For example, the indication information is used for indicating that the base station does not support the terminal in transmitting the first request message. That is, the base station does not have a capability to support the terminal in requesting the activation or deactivation of the preconfigured measurement gap. In order to activate or deactivate the preconfigured measurement gap in time and reduce the location delay, the base station may perform step 402 to transmit the second request message to the LMF, so as to request the LMF to transmit the third request message. The third request message is used for requesting the base station to activate or deactivate the preconfigured measurement gap.

Alternatively, the base station may not perform step 402. The LMF may transmit the third request message to the base station according to the content of the indication information. The base station may receive the third request message directly.

For example, the indication information is used for indicating that the base station does not allow the terminal to transmit the first request message. In order to activate or deactivate the preconfigured measurement gap in time and reduce the location delay, the base station may perform step 402 to transmit the second request message to the LMF, so as to request the LMF to transmit the third request message. The third request message is used for requesting the base station to activate or deactivate the preconfigured measurement gap.

Alternatively, the base station may not perform step 402. The LMF may transmit the third request message to the base station according to the content of the indication information. The base station may receive the third request message directly.

For example, under the condition that the indication information is used for indicating that the base station supports and/or allows the terminal to transmit the first request message, the base station may also perform step 402 to transmit the second request message to the LMF, so as to request the LMF to transmit the third request message. The third request message is used for requesting the base station to activate or deactivate the preconfigured measurement gap.

Alternatively, under the condition that the indication information is used for indicating that the base station supports and/or allows the terminal to transmit the first request message, step 402 may not be performed. The terminal transmits the first request message to the base station. The first request message is used for requesting the base station to activate or deactivate the preconfigured measurement gap. That is, the activation or deactivation of the preconfigured measurement gap may be requested by the terminal.

Alternatively, under the condition that the indication information is used for indicating that the base station supports and/or allows the terminal to transmit the first request message, step 402 may not be performed. The LMF may transmit the third request message to the base station according to the content of the indication information. The base station may receive the third request message directly.

For example, under the condition that the indication information is used for indicating that the base station supports the terminal in transmitting the first request message, and the base station temporarily does not allow the terminal to transmit the first request message, the base station may also perform step 402 to transmit the second request message to the LMF, so as to request the LMF to transmit the third request message. The third request message is used for requesting the base station to activate or deactivate the preconfigured measurement gap.

Alternatively, under the condition that the indication information is used for indicating that the base station supports the terminal in transmitting the first request message, and the base station temporarily does not allow the terminal to transmit the first request message, the base station may also not perform step 402. The terminal transmits the first request message to the base station. The first request message is used for requesting the base station to activate or deactivate the preconfigured measurement gap. That is, the activation or deactivation of the preconfigured measurement gap may be requested by the terminal.

Alternatively, under the condition that the indication information is used for indicating that the base station supports the terminal in transmitting the first request message, and the base station temporarily does not allow the terminal to transmit the first request message, step 402 may not be performed. The LMF may transmit the third request message to the base station according to the content of the indication information. The base station may receive the third request message directly.

Step 403: the base station receives the third request message transmitted by the LMF.

In the embodiment of the present disclosure, step 403 may be performed alternatively.

In a possible implementation, in a case where the indication information indicates that the base station does not support and/or does not allow the terminal to request the activation or deactivation of the preconfigured measurement gap, step 403 may be performed.

In a case where the base station transmits the second request message to the LMF, step 403 may specifically include:
the third request message transmitted by the LMF based on the second request message is received.

In a case where the base station does not transmit the second request message to the LMF, step 403 may specifically include:
the third request message transmitted by the LMF to the base station according to the indication information is received.

In another possible implementation, in a case where the indication information indicates that the base station supports and/or allows the terminal to request the activation or deactivation of the preconfigured measurement gap, step 403 may be performed.

In a case where the base station transmits the second request message to the LMF, step 403 may specifically include:
the third request message transmitted by the LMF based on the second request message is received.

In a case where the base station does not transmit the second request message to the LMF, step 403 may specifically include:
the third request message transmitted by the LMF to the base station according to the indication information is received.

In another possible implementation, in a case where the base station does not transmit the indication information, the base station performs step 402 to transmit the second request message to the LMF. The LMF transmits the third request message to the base station according to the second request message. The base station performs step 403 to receive the third request message transmitted by the LMF. In another possible implementation, in a case where the indication information indicates that the base station supports and/or allows the terminal to request the activation or deactivation of the preconfigured measurement gap, step 403 may not be performed.

Accordingly, the base station may receive the first request message transmitted by the terminal. The LMF does not need to transmit the third request message to the base station.

In another possible implementation, in a case where the indication information indicates that the base station supports the terminal in requesting the activation or deactivation of the preconfigured measurement gap, and the base station temporarily does not allow the terminal to transmit the first request message, step 403 may be performed.

In a case where the base station transmits the second request message to the LMF, step 403 may specifically include:
the third request message transmitted by the LMF based on the second request message is received.

In a case where the base station does not transmit the second request message to the LMF, step 403 may specifically include:
the third request message transmitted by the LMF to the base station according to the indication information is received.

After receiving the first request message from the terminal or the third request message from the LMF through the above method, the base station may transmit an activation message or a deactivation message to the terminal, so as to activate or deactivate the preconfigured measurement gap.

The base station may transmit the activation message or the deactivation message to the terminal via DL MAC CE.

In the embodiment, the base station may inform the LMF of whether the base station supports the terminal in requesting the activation or deactivation of the preconfigured measurement gap. The activation or deactivation of the preconfigured measurement gap may be guaranteed, accuracy and reliability of terminal positioning are improved, and a location delay is reduced.

In some embodiments, the embodiments of the present disclosure provide a method for transmitting information. With reference to FIG. 5, FIG. 5 is a flowchart of a method for transmitting information according to an embodiment. The method may be performed by a base station and may include steps 501-504.

Step 501: the base station receives a fourth request message transmitted by an LMF, where the fourth request message is used for requesting the base station to transmit indication information.

In the embodiment of the present disclosure, the LMF may actively transmit the fourth request message to the base station, and request the base station to transmit the indication information to the LMF via the fourth request message. The indication information is used for indicating whether the base station supports reception of a first request message transmitted by a terminal. The first request message is used for requesting the base station to activate or deactivate a preconfigured measurement gap.

In a possible implementation, the base station may receive the fourth request message transmitted by the LMF via a second NRPPa message.

In an instance, the second NRPPa message may be any of the following: a measurement preconfiguration required message; a transmission and receiving point information request (TRP information request) message; or other NRPPa messages.

The other NRPPa messages here are NRPPa messages other than the measurement preconfiguration required message and the transmission and receiving point information request message.

Step 502: the base station transmits the indication information to the LMF based on the fourth request message.

In the embodiment of the present disclosure, the base station may transmit the indication information to the LMF based on a request of the LMF, so as to inform the LMF of whether the base station supports reception of the first request message transmitted by the terminal. The first request message is used for requesting the base station to activate or deactivate the preconfigured measurement gap. The LMF may determine whether activation or deactivation of the preconfigured measurement gap is requested by the LMF according to the indication information.

In a possible implementation, the base station may transmit the indication information to the LMF via a first NRPPa message.

In an instance, the first NRPPa message may be any of the following: a measurement preconfiguration confirm message; a transmission and receiving point information response (TRP information response) message; or other NRPPa messages.

The other NRPPa messages here are NRPPa messages other than the measurement preconfiguration confirm message and the transmission and receiving point information response message.

In an instance, the LMF transmits the fourth request message to the base station via the second NRPPa message. The second NRPPa message is a measurement preconfiguration required message. Accordingly, the base station may transmit the indication information to the LMF via the first NRPPa message. The first NRPPa message is a measurement preconfiguration confirm message.

In another instance, the LMF transmits the fourth request message to the base station via the second NRPPa message. The second NRPPa message is a transmission and receiving point information request message. Accordingly, the base station may transmit the indication information to the LMF via the first NRPPa message. The first NRPPa message is a transmission and receiving point information response message.

In yet another instance, the LMF transmits the fourth request message to the base station via the second NRPPa message. The second NRPPa message is another second NRPPa message other than the measurement preconfiguration required message and the transmission and receiving point information request message. Accordingly, the base station may transmit the indication information to the LMF via the first NRPPa message. The first NRPPa message is another NRPPa message other than the measurement preconfiguration confirm message and the transmission and receiving point information response message for responding to the second NRPPa message.

The above are merely illustrative descriptions. The solutions in which the base station receives the fourth request message via the second NRPPa message, and transmits the indication information to the LMF via h the first NRPPa message according to the fourth request message should all fall within the protection scope of the present disclosure.

In a possible implementation, the indication information may be used for indicating at least one of the following: the base station supports the terminal in transmitting the first request message; the base station allows the terminal to transmit the first request message; the base station does not support the terminal in transmitting the first request message; or the base station does not allow the terminal to transmit the first request message.

In an instance, the indication information may be used for indicating that the base station supports the terminal in transmitting the first request message. That is, the base station has a capability to support the terminal in requesting activation or deactivation of the preconfigured measurement gap.

In another instance, the indication information may be used for indicating that the base station allows the terminal to transmit the first request message. That is, the base station has a capability to support the terminal in requesting activation or deactivation of the preconfigured measurement gap. The base station currently allows the terminal to transmit the first request message to the base station.

In another instance, the indication information may be used for indicating that the base station does not support the terminal in transmitting the first request message. That is, the base station does not have the capability to support the terminal in requesting activation or deactivation of the preconfigured measurement gap.

In another instance, the indication information may be used for indicating that the base station does not allow the terminal to transmit the first request message. In this case, the terminal may determine that the base station temporarily or permanently does not allow the terminal to transmit the first request message according to the indication information.

In another example, the indication information may be used for indicating that the base station supports the terminal in transmitting the first request message, and that the base station allows the terminal to transmit the first request message. That is, the base station has the capability to support the terminal in requesting the activation or deactivation of the preconfigured measurement gap. Moreover, the base station allows the terminal to transmit the first request message on the basis of loads, service demands, etc.

Alternatively, the indication information may be used for indicating that the base station supports the terminal in transmitting the first request message, and that the base station does not allow the terminal to transmit the first request message. That is, the base station has the capability to support the terminal in requesting the activation or deactivation of the preconfigured measurement gap. Moreover, the base station temporarily does not allow the terminal to transmit the first request message on the basis of loads, service demands, etc.

The above are merely illustrative descriptions. In practical application, the solutions in which the indication information is used for indicating whether the base station has the capability to support the terminal in requesting the activation or deactivation of the preconfigured measurement gap should all fall within a protection scope of the present disclosure.

In a possible implementation, the preconfigured measurement gap is at least used for the terminal to perform positioning-related measurement.

Certainly, the preconfigured measurement gap may also be used for the terminal to perform RRM, etc., which is not limited in the present disclosure.

Step 503: the base station transmits a second request message to the LMF, where the second request message is used for requesting the LMF to transmit a third request message.

In the embodiment of the present disclosure, step 503 may be performed alternatively. An implementation of step 503 is similar to an implementation of step 402, which is not repeated here.

Step 504: the base station receives the third request message transmitted by the LMF based on the second request message.

In the embodiment of the present disclosure, step 504 may be performed alternatively. An implementation of step 504 is similar to an implementation of step 403, which is not repeated here.

In the above embodiment, the base station may receive the fourth request message transmitted by the LMF, and transmit the indication information to the LMF based on the fourth request message. The activation or deactivation of the preconfigured measurement gap may be guaranteed, such that the accuracy and reliability of terminal positioning is improved, and a location delay is reduced.

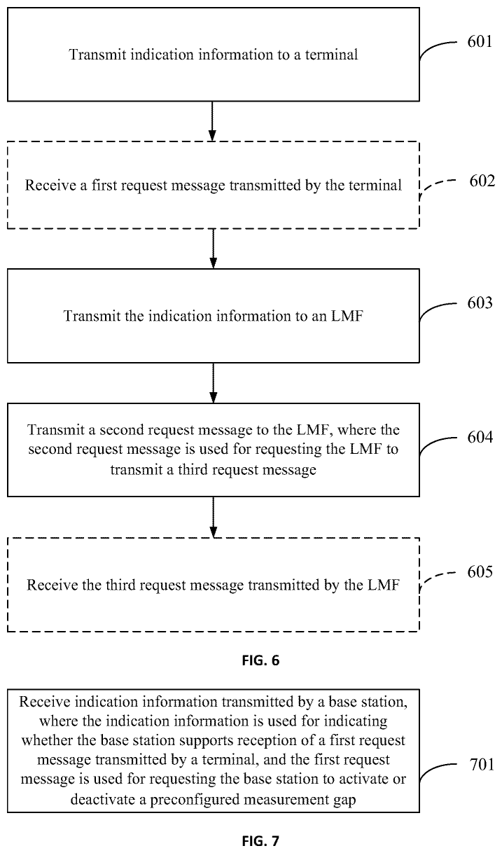

In some embodiments, the embodiments of the present disclosure provide a method for transmitting information. With reference to FIG. 6, FIG. 6 is a flowchart of a method for transmitting information according to an embodiment. The method may be performed by a base station and may include steps 601-605.

Step 601: the base station transmits indication information to a terminal.

The indication information is used for indicating whether the base station supports reception of a first request message transmitted by a terminal. The first request message is used for requesting the base station to activate or deactivate a preconfigured measurement gap.

An implementation of step 601 is similar to an implementation of step 301, which is not repeated here.

Step 602: the base station receives the first request message transmitted by the terminal.

In the embodiment of the present disclosure, step 602 is an optional step. A specific implementation is similar to an implementation of step 302, which is not repeated here.

Step 603: the base station transmits the indication information to an LMF.

In the embodiment of the present disclosure, the base station may transmit the indication information to the LMF based on a fourth request message transmitted by a core network device, for example, the LMF. A specific implementation is similar to implementations of step 501 to step 502, which is not repeated here.

Alternatively, the base station may transmit the indication information to the LMF directly. A specific implementation is similar to an implementation of step 401, which is not repeated here.

Step 604: the base station transmits a second request message to the LMF, where the second request message is used for requesting the LMF to transmit a third request message.

In the embodiment of the present disclosure, step 604 may be performed alternatively. An implementation of step 604 is similar to an implementation of step 402, which is not repeated here. In the embodiment of the present disclosure, step 603 may be performed alternatively. The base station performs step 604 directly. That is, the base station replaces the indication information with the second request message. A specific implementation has been described in the above embodiment, which is not repeated here.

Step 605: the base station receives the third request message transmitted by the LMF.

In the embodiment of the present disclosure, step 605 may be performed alternatively. An implementation of step 605 is similar to an implementation of step 403, which is not repeated here.

It should also be noted that step 602 and step 605 may be performed alternatively. That is, the base station may receive the first request message transmitted by the terminal and transmit an activation message or a deactivation message to the terminal based on the first request message, so as to activate or deactivate the preconfigured measurement gap. Alternatively, the base station may receive the third request message transmitted by the LMF and transmit an activation message or a deactivation message to the terminal based on the third request message, so as to activate or deactivate the preconfigured measurement gap.

In a possible implementation, the base station may transmit the activation message or the deactivation message to the terminal via DL MAC CE.

In the above embodiment, the base station may transmit the indication information to the terminal and the LMF to inform the terminal and the LMF of whether the base station supports reception of the first request message transmitted by the terminal. The first request message is used for requesting the base station to activate or deactivate the preconfigured measurement gap. The activation or deactivation of the preconfigured measurement gap may be guaranteed, accuracy and reliability of terminal positioning are improved, and a location delay is reduced.

The method for transmitting information provided in the present disclosure is then introduced from a terminal side.

The embodiments of the present disclosure provide a method for transmitting information. With reference to FIG. 7, FIG. 7 is a flowchart of a method for transmitting information according to an embodiment. The method may be performed by a terminal and may include step 701.

Step 701: the terminal receives indication information transmitted by a base station, where the indication information is used for indicating whether the base station supports reception of a first request message transmitted by the terminal, and the first request message is used for requesting the base station to activate or deactivate a preconfigured measurement gap.

In the embodiment of the present disclosure, the terminal may receive the indication information transmitted by the base station. The indication information is used for informing the terminal of whether the base station supports reception of the first request message transmitted by the terminal. The first request message is used for requesting the base station to activate or deactivate the preconfigured measurement gap. The terminal may determine whether activation or deactivation of the preconfigured measurement gap is requested by the terminal itself according to the indication information.

In a possible implementation, the terminal receives the indication information transmitted by the base station to the terminal in a case where the base station configures the preconfigured measurement gap for the terminal.

In a possible implementation, the indication information may be used for indicating at least one of the following: the base station supports the terminal in transmitting the first request message; the base station allows the terminal to transmit the first request message; the base station does not support the terminal in transmitting the first request message; or the base station does not allow the terminal to transmit the first request message.

In an instance, the indication information may be used for indicating that the base station supports the terminal in transmitting the first request message. That is, the base station has a capability to support the terminal in requesting activation or deactivation of the preconfigured measurement gap.

In another instance, the indication information may be used for indicating that the base station allows the terminal to transmit the first request message. That is, the base station has a capability to support the terminal in requesting activation or deactivation of the preconfigured measurement gap. The base station currently allows the terminal to transmit the first request message to the base station.

In another instance, the indication information may be used for indicating that the base station does not support the terminal in transmitting the first request message. That is, the base station does not have the capability to support the terminal in requesting activation or deactivation of the preconfigured measurement gap.

In another instance, the indication information may be used for indicating that the base station does not allow the terminal to transmit the first request message. In this case, the terminal may determine that the base station temporarily or permanently does not allow the terminal to transmit the first request message according to the indication information.

In another example, the indication information may be used for indicating that the base station supports the terminal in transmitting the first request message, and that the base station allows the terminal to transmit the first request message. That is, the base station has the capability to support the terminal in requesting the activation or deactivation of the preconfigured measurement gap. Moreover, the base station allows the terminal to transmit the first request message on the basis of loads, service demands, etc.

Alternatively, the indication information may be used for indicating that the base station supports the terminal in transmitting the first request message, and that the base station does not allow the terminal to transmit the first request message. That is, the base station has the capability to support the terminal in requesting the activation or deactivation of the preconfigured measurement gap. Moreover, the base station temporarily does not allow the terminal to transmit the first request message on the basis of loads, service demands, etc.

The above are merely illustrative descriptions. In practical application, the solutions in which the indication information is used for indicating whether the base station has the capability to support the terminal in requesting the activation or deactivation of the preconfigured measurement gap should all fall within a protection scope of the present disclosure.

In a possible implementation, the preconfigured measurement gap is at least used for the terminal to perform positioning-related measurement.

Certainly, the preconfigured measurement gap may also be used for the terminal to perform RRM, etc., which is not limited in the present disclosure.

In the embodiment, the terminal may receive the indication information transmitted by the base station, so as to determine whether the base station supports the terminal in requesting the activation or deactivation of the preconfigured measurement gap. The activation or deactivation of the preconfigured measurement gap may be guaranteed, accuracy and reliability of terminal positioning are improved, and a location delay is reduced.

In some optional embodiments, the embodiments of the present disclosure provide a method for transmitting information. With reference to FIG. 8, FIG. 8 is a flowchart of a method for transmitting information according to an embodiment. The method may be performed by a terminal and may include steps 801 and 802.

Step 801: the terminal receives indication information transmitted by a base station, where the indication information is used for indicating whether the base station supports reception of a first request message transmitted by the terminal, and the first request message is used for requesting the base station to activate or deactivate a preconfigured measurement gap.

A specific implementation is similar to an implementation of step 701, which is not repeated here.

Step 802: the terminal transmits the first request message to the base station in a case where the indication information indicates that the base station supports reception of the first request message transmitted by the terminal.

In the embodiment of the present disclosure, step 802 is an optional step.

In a case where the indication information indicates that the base station supports reception of the first request message transmitted by the terminal, and the terminal determines to request the activation or deactivation of the preconfigured measurement gap by itself, step 302 may be performed. In this case, the base station may receive the first request message transmitted by the terminal.

In an instance, the indication information indicates that the base station supports the terminal in transmitting the first request message. The terminal may determine whether to request the activation or deactivation of the preconfigured measurement gap by itself according to the indication information. Further, the terminal may perform step 802 to transmit the first request message to the base station.

Certainly, step 802 may not be performed in this case. That is, the base station may receive a third request message transmitted by an LMF. The third request message is used for requesting the base station to activate or deactivate the preconfigured measurement gap.

After receiving the first request message from the terminal or the third request message from the LMF, the base station may transmit an activation message or a deactivation message to the terminal. The terminal activates or deactivates the preconfigured measurement gap based on the received activation message or deactivation message.

The base station may transmit the activation message or the deactivation message to the terminal via DL MAC CE.

In another instance, the indication information indicates that the base station allows the terminal to transmit the first request message. The terminal may determine whether to request the activation or deactivation of the preconfigured measurement gap by itself according to the indication information. Further, step 802 may be performed. The first request message is transmitted to the base station.

Certainly, step 802 may not be performed in this case. That is, the base station may receive a third request message transmitted by an LMF. The third request message is used for requesting the base station to activate or deactivate the preconfigured measurement gap.

After receiving the first request message from the terminal or the third request message from the LMF, the base station may transmit an activation message or a deactivation message to the terminal. The terminal activates or deactivates the preconfigured measurement gap based on the received activation message or deactivation message.

The base station may transmit the activation message or the deactivation message to the terminal via DL MAC CE.

In another instance, in a case where the indication information indicates that the base station does not support the terminal in transmitting the first request message, step 802 may not be performed. That is, the terminal does not transmit the first request message to the base station. Under the condition that the base station does not support the terminal in transmitting the first request message, signaling resource waste caused by the terminal still transmitting the first request message to the base station is avoided.

Alternatively, the terminal may still perform step 802. The terminal transmits the first request message to the base station, but the base station cannot activate or deactivate the preconfigured measurement gap based on the first request message.

Moreover, the base station may receive a third request message transmitted by an LMF. The third request message is used for requesting the base station to activate or deactivate the preconfigured measurement gap. After receiving the third request message from the LMF, the base station may transmit an activation message or a deactivation message to the terminal. The terminal activates or deactivates the preconfigured measurement gap based on the received activation message or deactivation message. The base station may transmit the activation message or the deactivation message to the terminal via DL MAC CE. The activation or deactivation of a preconfigured measurement gap may be guaranteed, such that the accuracy and reliability of terminal positioning is improved, and a location delay is reduced.

In another instance, in a case where the indication information indicates that the base station does not allow the terminal to transmit the first request message, step 802 cannot be performed. That is, the terminal does not transmit the first request message to the base station, so as to avoid causing signaling resource wastes of the terminal.

Moreover, the base station may receive a third request message transmitted by an LMF. The third request message is used for requesting the base station to activate or deactivate the preconfigured measurement gap. After receiving the third request message from the LMF, the base station may transmit an activation message or a deactivation message to the terminal. The terminal activates or deactivates the preconfigured measurement gap based on the received activation message or deactivation message. The base station may transmit the activation message or the deactivation message to the terminal via DL MAC CE. The activation or deactivation of a preconfigured measurement gap may be guaranteed, such that the accuracy and reliability of terminal positioning is improved, and a location delay is reduced.

In another instance, the indication information indicates that the base station supports the terminal in transmitting the first request message, and that the base station allows the terminal to transmit the first request message. The terminal may determine whether to request the activation or deactivation of the preconfigured measurement gap by itself according to the indication information. Further, step 802 may be performed. The first request message is transmitted to the base station.

Certainly, step 802 may not be performed in this case. That is, the base station may receive a third request message transmitted by an LMF. The third request message is used for requesting the base station to activate or deactivate the preconfigured measurement gap.

After receiving the first request message from the terminal or the third request message from the LMF, the base station may transmit an activation message or a deactivation message to the terminal. The terminal activates or deactivates the preconfigured measurement gap based on the received activation message or deactivation message. The base station may transmit the activation message or the deactivation message to the terminal via DL MAC CE.

In another instance, in a case where the indication information indicates that the base station supports the terminal in transmitting the first request message, and that the base station does not allow the terminal to transmit the first request message, step 802 cannot be performed. That is, the terminal does not transmit the first request message to the base station. Signaling resource waste caused by the terminal still transmitting the first request message to the base station is avoided.

Moreover, the base station may receive a third request message transmitted by an LMF. The third request message is used for requesting the base station to activate or deactivate the preconfigured measurement gap. After receiving the third request message from the LMF, the base station may transmit an activation message or a deactivation message to the terminal. The terminal activates or deactivates the preconfigured measurement gap based on the received activation message or deactivation message. The base station may transmit the activation message or the deactivation message to the terminal via DL MAC CE. The activation or deactivation of a preconfigured measurement gap may be guaranteed, such that the accuracy and reliability of terminal positioning is improved, and a location delay is reduced. In a possible implementation, the terminal may transmit the first request message to the base station via a first message. The first message may be a UL MAC CE.

After the terminal transmits the first request message to the base station, the terminal may receive the activation message or the deactivation message transmitted by the base station. The terminal activates or deactivates the preconfigured measurement gap based on the received activation message or deactivation message.

In the embodiment, the terminal may receive the indication information transmitted by the base station, so as to determine whether the base station supports the terminal in requesting the activation or deactivation of the preconfigured measurement gap. The activation or deactivation of the preconfigured measurement gap may be guaranteed, accuracy and reliability of terminal positioning are improved, and a location delay is reduced.

The method for transmitting information provided in the present disclosure is then introduced from an LMF side.

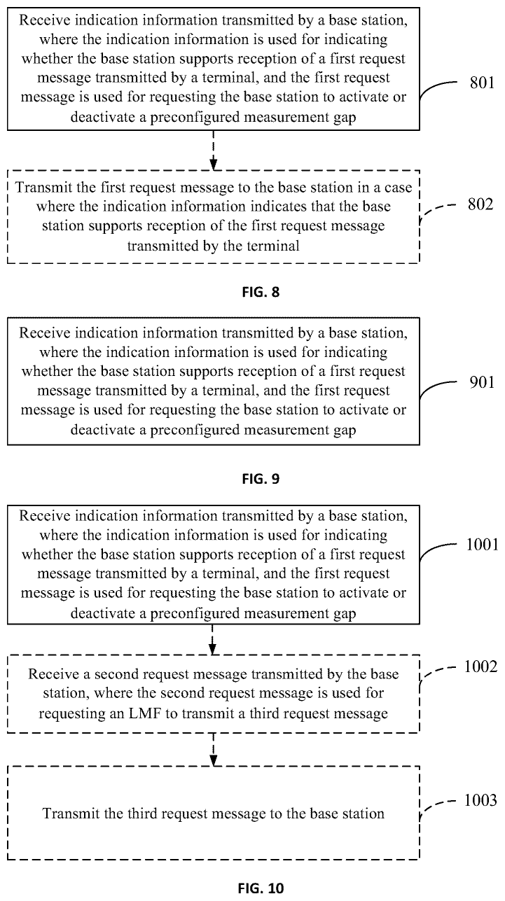

The embodiments of the present disclosure provide a method for transmitting information. With reference to FIG. 9, FIG. 9 is a flowchart of a method for transmitting information according to an embodiment. The method may be performed by a core network device, for example, an LMF, and may include step 901.

Step 901: the LMF receives indication information transmitted by a base station, where the indication information is used for indicating whether the base station supports reception of a first request message transmitted by a terminal, and the first request message is used for requesting the base station to activate or deactivate a preconfigured measurement gap.

In the embodiment of the present disclosure, the preconfigured measurement gap may be configured for the terminal by the base station. A process of configuring the preconfigured measurement gap for the terminal by the base station is similar to step 0 to step 4 shown in FIG. 1, which is not repeated here. Alternatively, the preconfigured measurement gap is at least used for the terminal to perform positioning-related measurement.

Before activating or deactivating the preconfigured measurement gap, step 901 may be performed. The indication information transmitted by the base station is received by the core network device, for example, the LMF.

In the embodiment of the present disclosure, the indication information is used for informing the LMF of whether the base station supports reception of the first request message transmitted by the terminal. The first request message is used for requesting the base station to activate or deactivate the preconfigured measurement gap. The LMF may determine whether activation or deactivation of the preconfigured measurement gap is requested by the LMF according to the indication information.

In a possible implementation, the base station may transmit the indication information to the LMF via a first NRPPa message.

In an instance, the first NRPPa message may be any of the following: a measurement preconfiguration confirm message; a transmission and receiving point information response message; or other NRPPa messages.

The other NRPPa messages here are NRPPa messages other than the measurement preconfiguration confirm message and the transmission and receiving point information response message.

In an instance, the indication information may be used for indicating that the base station supports the terminal in transmitting the first request message. That is, the base station has a capability to support the terminal in requesting activation or deactivation of the preconfigured measurement gap. In this case, the LMF may not transmit a third request message to the base station according to the indication information. The third request message is used for requesting the base station to activate or deactivate the preconfigured measurement gap. Certainly, in this case, the LMF may also transmit the third request message to the base station according to the indication information, which is not limited in the present disclosure.

In another instance, the indication information may be used for indicating that the base station allows the terminal to transmit the first request message. That is, the base station has a capability to support the terminal in requesting activation or deactivation of the preconfigured measurement gap. The base station currently allows the terminal to transmit the first request message to the base station. In this case, the LMF may not transmit a third request message to the base station according to the indication information. The third request message is used for requesting the base station to activate or deactivate the preconfigured measurement gap. Certainly, in this case, the LMF may also transmit the third request message to the base station according to the indication information, which is not limited in the present disclosure.

In another instance, the indication information may be used for indicating that the base station does not support the terminal in transmitting the first request message. That is, the base station does not have the capability to support the terminal in requesting activation or deactivation of the preconfigured measurement gap. In this case, the LMF may transmit a third request message to the base station according to the indication information. The third request message is used for requesting the base station to activate or deactivate the preconfigured measurement gap.

In another instance, the indication information may be used for indicating that the base station does not allow the terminal to transmit the first request message. In this case, the terminal may determine that the base station temporarily or permanently does not allow the terminal to transmit the first request message according to the indication information. In this case, the LMF may transmit a third request message to the base station according to the indication information. The third request message is used for requesting the base station to activate or deactivate the preconfigured measurement gap.

In another example, the indication information may be used for indicating that the base station supports the terminal in transmitting the first request message, and that the base station allows the terminal to transmit the first request message. That is, the base station has the capability to support the terminal in requesting the activation or deactivation of the preconfigured measurement gap. Moreover, the base station allows the terminal to transmit the first request message on the basis of loads, service demands, etc. In this case, the LMF may transmit a third request message to the base station according to the indication information or not. The third request message is used for requesting the base station to activate or deactivate the preconfigured measurement gap.

Alternatively, the indication information may be used for indicating that the base station supports the terminal in transmitting the first request message, and that the base station does not allow the terminal to transmit the first request message. That is, the base station has the capability to support the terminal in requesting the activation or deactivation of the preconfigured measurement gap. Moreover, the base station temporarily does not allow the terminal to transmit the first request message on the basis of loads, service demands, etc. In this case, the LMF may transmit a third request message to the base station according to the indication information. The third request message is used for requesting the base station to activate or deactivate the preconfigured measurement gap.

The above are merely illustrative descriptions. In practical application, the solutions in which the indication information is used for indicating whether the base station has the capability to support the terminal in requesting the activation or deactivation of the preconfigured measurement gap should all fall within a protection scope of the present disclosure.

In a possible implementation, the preconfigured measurement gap is at least used for the terminal to perform positioning-related measurement.

Certainly, the preconfigured measurement gap may also be used for the terminal to perform RRM, etc., which is not limited in the present disclosure.

In the embodiment, the LMF may receive the indication information transmitted by the base station, so as to determine whether the base station supports the terminal in requesting the activation or deactivation of the preconfigured measurement gap. The activation or deactivation of the preconfigured measurement gap may be guaranteed, accuracy and reliability of terminal positioning are improved, and a location delay is reduced.

In some embodiments, the embodiments of the present disclosure provide a method for transmitting information. With reference to FIG. 10, FIG. 10 is a flowchart of a method for transmitting information according to an embodiment. The method may be performed by a core network device, for example, an LMF, and may include steps 1001-1003.

Step 1001: the LMF receives indication information transmitted by a base station, where the indication information is used for indicating whether the base station supports reception of a first request message transmitted by a terminal, and the first request message is used for requesting the base station to activate or deactivate a preconfigured measurement gap.

An implementation of step 1001 is similar to an implementation of step 901, which is not repeated here.

Step 1002: the LMF receives a second request message transmitted by the base station, where the second request message is used for requesting the LMF to transmit a third request message.

In the embodiment of the present disclosure, step 1002 may be performed alternatively.

In a possible implementation, in a case where the indication information indicates that the base station does not support and/or does not allow the terminal to request the activation or deactivation of the preconfigured measurement gap, step 1002 may be performed. The second request message transmitted by the base station is received. The second request message is used for requesting the LMF to transmit the third request message to the base station. The third request message is used for requesting the base station to activate or deactivate the preconfigured measurement gap.

In another possible implementation, in a case where the indication information indicates that the base station supports and/or allows the terminal in requesting/to request the activation or deactivation of the preconfigured measurement gap, step 1002 may not be performed. That is, the terminal may transmit the first request message to the base station. The first request message is used for requesting the base station to activate or deactivate the preconfigured measurement gap.

In another possible implementation, in a case where the indication information indicates that the base station supports and/or allows the terminal to request the activation or deactivation of the preconfigured measurement gap, step 1002 may be performed. That is, the LMF may receive the second request message transmitted by the base station. The second request message is used for requesting the LMF to transmit the third request message to the base station. The third request message is used for requesting the base station to activate or deactivate the preconfigured measurement gap. Accordingly, the terminal may not transmit the first request message to the base station anymore.

In another possible implementation, regardless of a content of the indication information, step 1002 may be performed. That is, the base station does not support or allow the terminal in requesting or to request the activation or deactivation of the preconfigured measurement gap by default. In this case, the LMF may receive the second request message transmitted by the base station. The second request message is used for requesting the LMF to transmit the third request message to the base station. The third request message is used for requesting the base station to activate or deactivate the preconfigured measurement gap. Accordingly, the terminal may not transmit the first request message to the base station anymore.

In another possible implementation, step 1002 may be directly performed without performing step 1001. Accordingly, subsequent step 1003 may be then performed. That is, the LMF may receive no indication information transmitted by the base station. In a case of receiving the second request message transmitted by the base station, the LMF determines that the base station replaces the indication information with the second request message, and determines that the base station does not support or allow the terminal in transmitting or to transmit the first request message. In this case, the LMF may directly transmit the third request message to the base station according to the second request message.

It should be noted that the third request message and the first request message have similar functions. Both of them are used for requesting the base station to activate or deactivate the preconfigured measurement gap. A difference lies in that the third request message is transmitted to the base station by the LMF, and the first request message is transmitted to the base station by the terminal. Moreover, a message format and content of the third request message are different from those of the first request message.

In a possible implementation, the LMF may receive the second request message transmitted by the base station via a first NRPPa message.

In an instance, the first NRPPa message may be any of the following: a measurement preconfiguration confirm message; a transmission and receiving point information response message; or other NRPPa messages.

The other NRPPa messages here are NRPPa messages other than the measurement preconfiguration confirm message and the transmission and receiving point information response message.

That is, the LMF may receive the indication information and the second request message transmitted by the base station via the first NRPPa message.

For example, the indication information is used for indicating that the base station does not support the terminal in transmitting the first request message. That is, the base station does not have a capability to support the terminal in requesting the activation or deactivation of the preconfigured measurement gap. In order to activate or deactivate the preconfigured measurement gap in time and reduce the location delay, step 1002 may be performed. The second request message transmitted by the base station is received. The second request message is used for requesting the LMF to transmit the third request message to the base station. The third request message is used for requesting the base station to activate or deactivate the preconfigured measurement gap.

Alternatively, step 1002 may not be performed. The LMF may transmit the third request message to the base station according to the content of the indication information. The base station may receive the third request message directly.

For example, the indication information is used for indicating that the base station does not allow the terminal to transmit the first request message. In order to activate or deactivate the preconfigured measurement gap in time and reduce the location delay, step 402 may be performed. The LMF receives the second request message transmitted by the base station. The second request message is used for requesting the LMF to transmit the third request message to the base station. The third request message is used for requesting the base station to activate or deactivate the preconfigured measurement gap.

Alternatively, step 1002 may not be performed. The LMF may transmit the third request message to the base station according to the content of the indication information. The base station may receive the third request message directly.

For example, under the condition that the indication information is used for indicating that the base station supports and/or allows the terminal in transmitting/to transmit the first request message, step 1002 may also be performed. The LMF receives the second request message transmitted by the base station. The second request message is used for requesting the LMF to transmit the third request message to the base station. The third request message is used for requesting the base station to activate or deactivate the preconfigured measurement gap.

Alternatively, under the condition that the indication information is used for indicating that the base station supports and/or allows the terminal in transmitting/to transmit the first request message, step 1002 may not be performed. The terminal transmits the first request message to the base station. The first request message is used for requesting the base station to activate or deactivate the preconfigured measurement gap. That is, the activation or deactivation of the preconfigured measurement gap may be requested by the terminal.

Alternatively, under the condition that the indication information is used for indicating that the base station supports and/or allows the terminal in transmitting/to transmit the first request message, step 1002 may not be performed. The LMF may transmit the third request message to the base station according to the content of the indication information. The base station may receive the third request message directly.

For example, under the condition that the indication information is used for indicating that the base station supports the terminal in transmitting the first request message, and the base station temporarily does not allow the terminal to transmit the first request message, step 1002 may also be performed. The LMF receives the second request message transmitted by the base station. The second request message is used for requesting the LMF to transmit the third request message to the base station. The third request message is used for requesting the base station to activate or deactivate the preconfigured measurement gap.

Alternatively, under the condition that the indication information is used for indicating that the base station supports the terminal in transmitting the first request message, and the base station temporarily does not allow the terminal to transmit the first request message, step 1002 may also not be performed. The terminal transmits the first request message to the base station. The first request message is used for requesting the base station to activate or deactivate the preconfigured measurement gap. That is, the activation or deactivation of the preconfigured measurement gap may be requested by the terminal.

Alternatively, under the condition that the indication information is used for indicating that the base station supports the terminal in transmitting the first request message, and the base station temporarily does not allow the terminal to transmit the first request message, step 1002 may not be performed. The LMF may transmit the third request message to the base station according to the content of the indication information. The base station may receive the third request message directly.

Step 1003: the LMF transmits the third request message to the base station.

In the embodiment of the present disclosure, step 1003 may be performed alternatively.

In a possible implementation, in a case where the indication information indicates that the base station does not support and/or allow the terminal to request the activation or deactivation of the preconfigured measurement gap, step 1003 may be performed.

In a case where the base station transmits the second request message to the LMF, step 1003 may specifically include:
the third request message is transmitted to the base station based on the second request message.

In a case where the base station does not transmit the second request message to the LMF, step 1003 may specifically include:
the third request message is transmitted to the base station according to the indication information.

In another possible implementation, in a case where the indication information indicates that the base station supports and/or allows the terminal to request the activation or deactivation of the preconfigured measurement gap, step 1003 may be performed.

In a case where the base station transmits the second request message to the LMF, step 1003 may specifically include:
the third request message is transmitted to the base station based on the second request message.

In a case where the base station does not transmit the second request message to the LMF, step 1003 may specifically include:
the third request message is transmitted to the base station according to the indication information.

In another possible implementation, in a case where the LMF does not receive the indication information transmitted by the base station, step 1002 is performed. The second request message transmitted by the base station is received. The LMF transmits the third request message to the base station according to the second request message. Step 1003 is performed. The third request message is transmitted to the base station.

In another possible implementation, in a case where the indication information indicates that the base station supports and/or allows the terminal to request the activation or deactivation of the preconfigured measurement gap, step 1003 may not be performed.

Accordingly, the base station may receive the first request message transmitted by the terminal. The LMF does not need to transmit the third request message to the base station.

In another possible implementation, in a case where the indication information indicates that the base station supports the terminal in requesting the activation or deactivation of the preconfigured measurement gap, and the base station temporarily does not allow the terminal to transmit the first request message, step 1003 may be performed.

In a case where the base station transmits the second request message to the LMF, step 1003 may specifically include:
the third request message is transmitted to the base station based on the second request message.

In a case where the base station does not transmit the second request message to the LMF, step 1003 may specifically include:
the third request message is transmitted to the base station according to the indication information.

After receiving the third request message from the LMF through the above method, the base station may transmit an activation message or a deactivation message to the terminal, so as to activate or deactivate the preconfigured measurement gap.

The base station may transmit the activation message or the deactivation message to the terminal via DL MAC CE.

In the embodiment, the base station may inform the LMF of whether the base station supports the terminal in requesting the activation or deactivation of the preconfigured measurement gap. The activation or deactivation of the preconfigured measurement gap may be guaranteed, accuracy and reliability of terminal positioning are improved, and a location delay is reduced.

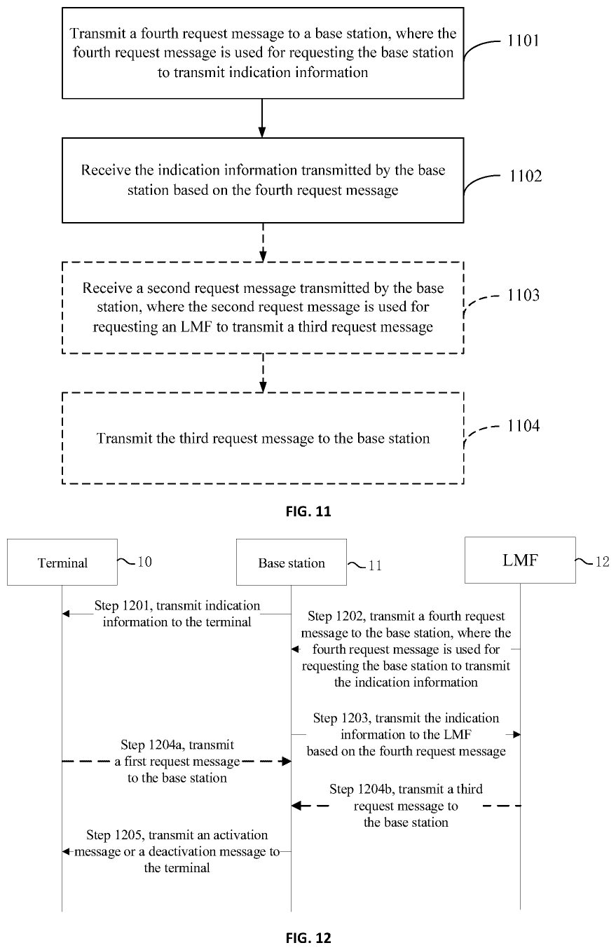

In some embodiments, the embodiments of the present disclosure provide a method for transmitting information. With reference to FIG. 11, FIG. 11 is a flowchart of a method for transmitting information according to an embodiment. The method may be performed by a core network device, for example, an LMF, and may include steps 1101-1104.

Step 1101: the LMF transmits a fourth request message to a base station, where the fourth request message is used for requesting the base station to transmit indication information.

In the embodiment of the present disclosure, the LMF may actively transmit the fourth request message to the base station, and request the base station to transmit the indication information to the LMF via the fourth request message. The indication information is used for indicating whether the base station supports reception of a first request message transmitted by a terminal. The first request message is used for requesting the base station to activate or deactivate a preconfigured measurement gap.

In a possible implementation, the LMF may transmit the fourth request message to the base station via a second NRPPa message.

In an instance, the second NRPPa message may be any of the following: a measurement preconfiguration required message; a transmission and receiving point information request message; or other NRPPa messages.

The other NRPPa messages here are NRPPa messages other than the measurement preconfiguration required message and the transmission and receiving point information request message.

Step 1102: the LMF receives the indication information transmitted by the base station based on the fourth request message.

In the embodiment of the present disclosure, the base station may transmit the indication information to the LMF based on a request of the LMF, so as to inform the LMF of whether the base station supports reception of the first request message transmitted by the terminal. The first request message is used for requesting the base station to activate or deactivate the preconfigured measurement gap. The LMF may determine whether activation or deactivation of the preconfigured measurement gap is requested by the LMF according to the indication information.

In a possible implementation, the LMF may receive the indication information transmitted by the base station via a first NRPPa message.

In an instance, the first NRPPa message may be any of the following: a measurement preconfiguration confirm message; a transmission and receiving point information response message; or other NRPPa messages.

The other NRPPa messages here are NRPPa messages other than the measurement preconfiguration confirm message and the transmission and receiving point information response message.

In an instance, the LMF may transmit the fourth request message to the base station via the second NRPPa message. The second NRPPa message is a measurement preconfiguration required message. Accordingly, the base station may transmit the indication information to the LMF via the first NRPPa message. The first NRPPa message is a measurement preconfiguration confirm message.

In another instance, the LMF transmits the fourth request message to the base station via the second NRPPa message. The second NRPPa message is a transmission and receiving point information request message. Accordingly, the base station may transmit the indication information to the LMF via the first NRPPa message. The first NRPPa message is a transmission and receiving point information response message.

In yet another instance, the LMF transmits the fourth request message to the base station via the second NRPPa message. The second NRPPa message is another second NRPPa message other than the measurement preconfiguration required message and the transmission and receiving point information request message. Accordingly, the base station may transmit the indication information to the LMF via the first NRPPa message. The first NRPPa message is another NRPPa message other than the measurement preconfiguration confirm message and the transmission and receiving point information response message for responding to the second NRPPa message.

The above are merely illustrative descriptions. The solutions in which the LMF transmits the fourth request message to the base station via the second NRPPa message, and receives the indication information transmitted by the base station via the first NRPPa message according to the fourth request message should all fall within the protection scope of the present disclosure.

In a possible implementation, the indication information may be used for indicating at least one of the following: the base station supports the terminal in transmitting the first request message; the base station allows the terminal to transmit the first request message; the base station does not support the terminal in transmitting the first request message; or the base station does not allow the terminal to transmit the first request message.

In an instance, the indication information may be used for indicating that the base station supports the terminal in transmitting the first request message. That is, the base station has a capability to support the terminal in requesting activation or deactivation of the preconfigured measurement gap.

In another instance, the indication information may be used for indicating that the base station allows the terminal to transmit the first request message. That is, the base station has a capability to support the terminal in requesting activation or deactivation of the preconfigured measurement gap. The base station currently allows the terminal to transmit the first request message to the base station.

In another instance, the indication information may be used for indicating that the base station does not support the terminal in transmitting the first request message. That is, the base station does not have the capability to support the terminal in requesting activation or deactivation of the preconfigured measurement gap.

In another instance, the indication information may be used for indicating that the base station does not allow the terminal to transmit the first request message. In this case, the terminal may determine that the base station temporarily or permanently does not allow the terminal to transmit the first request message according to the indication information.

In another example, the indication information may be used for indicating that the base station supports the terminal in transmitting the first request message, and that the base station allows the terminal to transmit the first request message. That is, the base station has the capability to support the terminal in requesting the activation or deactivation of the preconfigured measurement gap. Moreover, the base station allows the terminal to transmit the first request message on the basis of loads, service demands, etc.

Alternatively, the indication information may be used for indicating that the base station supports the terminal in transmitting the first request message, and that the base station does not allow the terminal to transmit the first request message. That is, the base station has the capability to support the terminal in requesting the activation or deactivation of the preconfigured measurement gap. Moreover, the base station temporarily does not allow the terminal to transmit the first request message on the basis of loads, service demands, etc.

The above are merely illustrative descriptions. In practical application, the solutions in which the indication information is used for indicating whether the base station has the capability to support the terminal in requesting the activation or deactivation of the preconfigured measurement gap should all fall within a protection scope of the present disclosure.

In a possible implementation, the preconfigured measurement gap is at least used for the terminal to perform positioning-related measurement.

Certainly, the preconfigured measurement gap may also be used for the terminal to perform RRM, etc., which is not limited in the present disclosure.

Step 1103: the LMF receives a second request message transmitted by the base station, where the second request message is used for requesting the LMF to transmit a third request message.

In the embodiment of the present disclosure, step 1103 may be performed alternatively. An implementation of step 1103 is similar to an implementation of step 1002, which is not repeated here.

Step 1104: the LMF transmits the third request message to the base station.

In the embodiment of the present disclosure, step 1104 may be performed alternatively. An implementation of step 1104 is similar to an implementation of step 1003, which is not repeated here.

In the above embodiment, the LMF may transmit the fourth request message to the base station, and receive the indication information transmitted by the base station to be LMF based on the fourth request message. The activation or deactivation of the preconfigured measurement gap may be guaranteed, such that the accuracy and reliability of terminal positioning is improved, and a location delay is reduced.

In some embodiments, the embodiments of the present disclosure provide a method for transmitting information. With reference to FIG. 12, FIG. 12 is a flowchart of a method for transmitting information according to an embodiment. The method may include steps 1201-1204.

Step 1201: a base station 11 transmits indication information to a terminal 10.

The indication information is used for indicating whether the base station supports reception of a first request message transmitted by a terminal. The first request message is used for requesting the base station to activate or deactivate a preconfigured measurement gap.

In the embodiment of the present disclosure, an implementation of step 1201 is similar to an implementation of step 301, which is not repeated here.

Step 1202: an LMF 12 transmits a fourth request message to a base station 11, where the fourth request message is used for requesting the base station 11 to transmit indication information.

In the embodiment of the present disclosure, an implementation of step 1202 is similar to an implementation of step 1101, which is not repeated here.

Step 1203: the base station 11 transmits the indication information to a core network device based on the fourth request message.

In the embodiment of the present disclosure, an implementation of step 1203 is similar to an implementation of step 602, which is not repeated here.

In the embodiment of the present disclosure, step 1203 may not be performed. That is, the base station does not transmit the indication information to the core network device, for example, the LMF. The base station may transmit a second request message to the LMF according to the fourth request message, to request the LMF to transmit a third request message to the base station. That is, the base station replaces the indication information with the second request message.

Step 1204a: the terminal 10 transmits a first request message to the base station 11.

In the embodiment of the present disclosure, an implementation of step 1204a is similar to an implementation of step 802, which is not repeated here.

Step 1204b: the LMF 12 transmits a third request message to the base station 11.

In the embodiment of the present disclosure, an implementation of step 1204b is similar to an implementation of step 1003, which is not repeated here.

Certainly, the core network device, for example, the LMF, may also transmit the third request message to the base station based on the second request message transmitted by the base station. A specific implementation is similar to implementations of step 1002 to step 1003, which is not repeated here.

Either step 1204a or step 1204b may be performed. That is, the base station receives the first request message transmitted by the terminal, or receives the third request message transmitted by the LMF.

It should be noted that in the present disclosure, the third request message and the first request message have similar functions. Both of them are used for requesting the base station to activate or deactivate the preconfigured measurement gap. A difference lies in that the third request message is transmitted to the base station by the LMF, and the first request message is transmitted to the base station by the terminal. Moreover, a message format and content of the third request message are different from those of the first request message.

Step 1205: the base station 11 transmits an activation message or a deactivation message to the terminal 10.

In the embodiment of the present disclosure, the base station may transmit the activation message or the deactivation message to the terminal via DL MAC CE, so as to activate or deactivate the preconfigured measurement gap.

In a possible implementation, the preconfigured measurement gap is at least used for the terminal to perform positioning-related measurement.

Certainly, the preconfigured measurement gap may also be used for the terminal to perform RRM, etc., which is not limited in the present disclosure.

In the embodiment, the indication information may be transmitted by the base station. The indication information is used for indicating whether the base station supports reception of the first request message transmitted by the terminal. The first request message is used for requesting the base station to activate or deactivate the preconfigured measurement gap, that is, the base station may inform the terminal and the LMF of whether the base station supports the terminal in requesting the activation or deactivation of the preconfigured measurement gap. The activation or deactivation of a preconfigured measurement gap may be guaranteed, accuracy and reliability of terminal positioning are improved, and a location delay is reduced.

It can be understood that in the above embodiment, information transmission steps performed by the core network device are described by taking the LMF as an instance. In practical application, a process of using other core network devices to perform the above solution also falls within the protection scope of the present disclosure.

Corresponding to the foregoing embodiment for an application function implementation method, the present disclosure further provides an embodiment for an application function implementation apparatus.

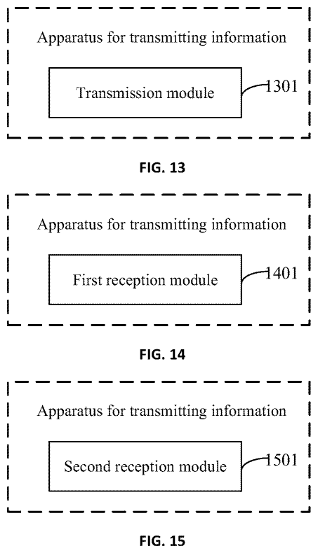

With reference to FIG. 13, FIG. 13 is a block diagram of an apparatus for transmitting information according to an example. The apparatus is applied to a base station and includes a transmission module 1301.

The transmission module 1301 is configured to transmit indication information, where the indication information is used for indicating whether the base station supports reception of a first request message transmitted by a terminal, and the first request message is used for requesting the base station to activate or deactivate a preconfigured measurement gap.

With reference to FIG. 14, FIG. 14 is a block diagram of an apparatus for transmitting information according to an example. The apparatus is applied to a terminal and includes a first reception module 1401.

The first reception module 1401 is configured to receive indication information transmitted by a base station, where the indication information is used for indicating whether the base station supports reception of a first request message transmitted by the terminal, and the first request message is used for requesting the base station to activate or deactivate a preconfigured measurement gap.

With reference to FIG. 15, FIG. 15 is a block diagram of an apparatus for transmitting information according to an example. The apparatus is applied to a location management function (LMF) and includes a second reception module 1501.

The second reception module 1501 is configured to receive indication information transmitted by a base station, where the indication information is used for indicating whether the base station supports reception of a first request message transmitted by a terminal, and the first request message is used for requesting the base station to activate or deactivate a preconfigured measurement gap.

Since the apparatus embodiment basically corresponds to the method embodiment, reference may be made to some description of the method embodiment for the relevant parts. The apparatus embodiment described above is merely illustrative. The elements described as separate components may be physically separated or not. The component shown as an element may be a physical element or not. That is, the components may be positioned in one place or distributed over a plurality of network elements. Some or all modules may be selected as required actually to implement the solution of the present disclosure. Those of ordinary skill in the art can understand and implement the present disclosure without creative efforts.

Accordingly, the present disclosure further provides a non-transitory computer-readable storage medium. The storage medium stores a computer program. The computer program is used for performing any one of the methods for transmitting information on a base station side.

Accordingly, the present disclosure further provides a non-transitory computer-readable storage medium. The storage medium stores a computer program. The computer program is used for performing any one of the methods for transmitting information on a terminal side.

Accordingly, the present disclosure further provides a non-transitory computer-readable storage medium. The storage medium stores a computer program. The computer program is used for performing any one of the methods for transmitting information on an LMF side.

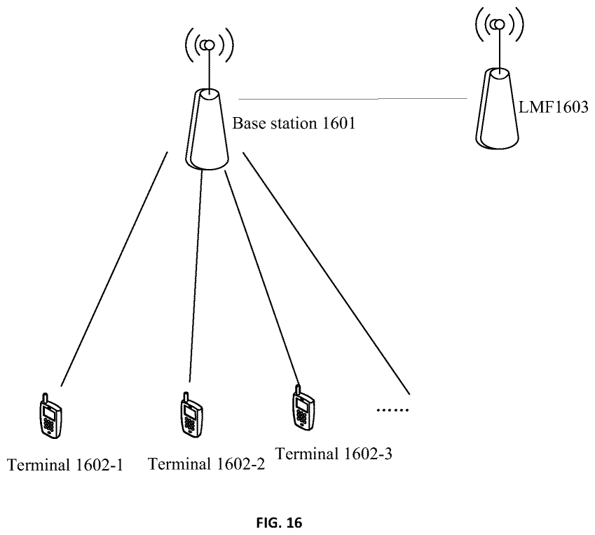

Accordingly, the present disclosure further provides a system for transmitting information. With reference to FIG. 16, FIG. 16 is a block diagram of a system for transmitting information according to an example. The system includes a base station 1601, a terminal 1602 and an LMF 1603.

The base station 1601 is used for performing any one of the methods for transmitting information on a base station side;

The terminal 1602 is used for performing any one of the methods for transmitting information on a terminal side; and

The LMF 1603 is used for performing any one of the methods for transmitting information on an LMF side.

A plurality of terminals 1602 may be provided, for example, including terminal 1602-1, terminal 1602-2, terminal 1602-3, etc. in FIG. 16.

The LMF 1603 is a type of core network device.

Accordingly, the present disclosure further provides an apparatus for transmitting information. The apparatus includes:
one or more processors, and
a memory for storing processor-executable instructions, where
the one or more processors are configured to perform any one of the methods for transmitting information on a base station side.

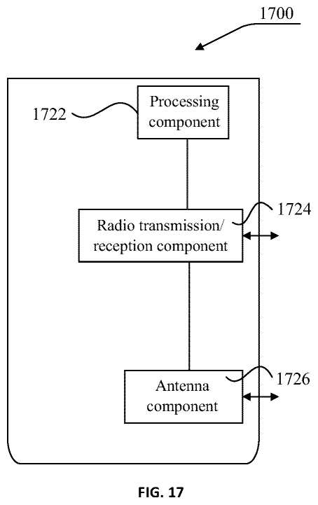

With reference to FIG. 17, FIG. 17 is a schematic structural diagram of an apparatus 1700 for transmitting information according to an example. The apparatus 1700 may be provided as a base station. With reference to FIG. 17, the apparatus 1700 includes a processing component 1722, a radio transmission/reception component 1724, an antenna component 1726, and a signal processing portion specific to a radio interface. The processing component 1722 may further include at least one processor.

One processor in the processing component 1722 may be configured to perform any one of the methods for transmitting information on a base station side.

Accordingly, the present disclosure further provides an apparatus for transmitting information. The apparatus includes:
one or more processors, and
a memory for storing processor-executable instructions, where
the one or more processors are configured to perform any one of the methods for transmitting information on a terminal side.

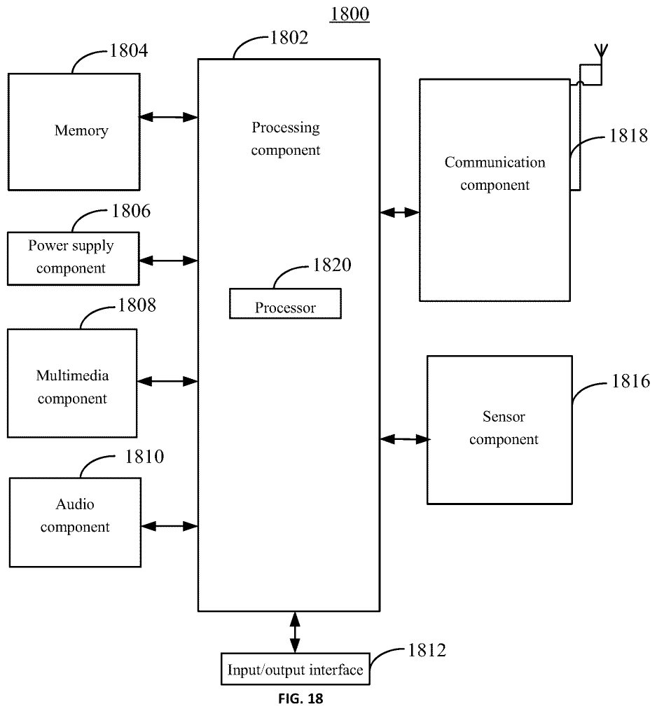

FIG. 18 is a block diagram of an apparatus 1800 for transmitting information according to an example. For example, the apparatus 1800 may be a terminal such as a mobile phone, a tablet computer, an e-book reader, a multimedia playing device, a wearable device, vehicle-mounted user equipment, an iPad, or a smart television.

With reference to FIG. 18, the apparatus 1800 may include one or more of the following components: a processing component 1802, a memory 1804, a power supply component 1806, a multimedia component 1808, an audio component 1810, an input/output (I/O) interface 1812, a sensor component 1816, and a communication component 1818.

The processing component 1802 generally controls overall operations of the apparatus 1800, for example, operations associated with display, phone calls, random data access, camera operations, and recording operations. The processing component 1802 may include one or more processors 1820 to execute instructions, so as to complete all or some steps of the above method for transmitting information. Moreover, the processing component 1802 may include one or more modules that facilitate interaction between the processing component 1802 and other components. For example, the processing component 1802 may include a multimedia module, so as to facilitate interaction between the multimedia component 1808 and the processing component 1802. For another example, the processing component 1802 may read an executable instruction from the memory to implement the steps of the method for transmitting information according to each embodiment.

The memory 1804 is configured to support the operation on the apparatus 1800 by storing various types of data. Instances of such data include an instruction, operated on the apparatus 1800, for any application or method, contact data, phonebook data, messages, pictures, videos, etc. The memory 1804 may be implemented through any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The power supply component 1806 supplies power to the various components of the apparatus 1800. The power supply component 1806 may include a power supply management system, one or more power supplies, and other components associated with power generation, management, and distribution for the apparatus 1800.

The multimedia component 1808 includes a display screen that provides an output interface between the apparatus 1800 and a user. In some embodiments, the multimedia component 1808 includes a front-facing camera and/or a rear-facing camera. When the apparatus 1800 is in an operation mode, such as a photographing mode or a video mode, the front-facing camera and/or the rear-facing camera may receive external multimedia data. Each of the front-facing camera and the rear-facing camera may be a fixed optical lens system or have a focal length and an optical zoom capability.

The audio component 1810 is configured to output and/or input audio signals. For example, the audio component 1810 includes a microphone (MIC) configured to receive external audio signals when the apparatus 1800 is in the operation mode, for example, a calling mode, a recording mode, or a speech recognition mode. The audio signals received may be further stored in the memory 1804 or transmitted via the communication component 1818. In some embodiments, the audio component 1810 further includes a speaker used to output an audio signal.

The I/O interface 1812 provides an interface between the processing component 1802 and a peripheral interface module, which may be a keyboard, a click wheel, a button, etc. These buttons may include, but are not limited to, a home button, a volume button, a start button, and a lock button.

The sensor component 1816 includes one or more sensors for providing state assessments of various aspects for the apparatus 1800. For example, the sensor component 1816 may detect an on/off state of the apparatus 1800 and relative positioning of the components. For example, the components are a display and a keypad of the apparatus 1800. The sensor component 1816 may also detect a change in position of the apparatus 1800 or a component of the apparatus 1800, the presence or absence of contact between the user and the apparatus 1800, orientation or acceleration/deceleration of the apparatus 1800, and temperature variation of the apparatus 1800. The sensor component 1816 may include a proximity sensor configured to detect presence of nearby objects in absence of any physical contact. The sensor component 1816 may further include a light sensor, such as a complementary metal-oxide-semiconductor transistor (CMOS) or charge coupled device (CCD) image sensor for use in imaging applications. In some embodiments, the sensor component 1816 may further include an acceleration sensor, a gyroscope sensor, a magnetic sensor, a pressure sensor, or a temperature sensor.

The communication component 1818 is configured to facilitate wired or wireless communication between the apparatus 1800 and other devices. The apparatus 1800 may access a radio network based on a communication standard, such as wireless fidelity (Wi-Fi), 2nd generation (2G), 3rd generation (3G), 4th generation (4G), 5th generation (5G), or 6th generation (6G), or their combinations. In an example, the communication component 1818 receives a broadcast signal or broadcast related information from an external broadcast management system via a broadcast channel. In an example, the communication component 1818 further includes a near field communication (NFC) module, so as to facilitate short-range communication. For example, the NFC module may be implemented based on a radio frequency identification (RFID) technology, an infrared data association (IrDA) technology, an ultra wide band (UWB) technology, a Bluetooth (BT) technology, etc.

In an example, the apparatus 1800 may be configured to perform the above method for transmitting information on a terminal side by being implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, etc.

A non-transitory machine-readable storage medium including instructions, for example, a memory 1804 including an instruction is further provided in an example. The above instructions may complete the above method for transmitting information by being executed by a processor 1820 of an apparatus 1800. For example, the non-transitory computer-readable storage medium may be an ROM, a random access memory (RAM), a compact disk read-only memory (CD-ROM), a magnetic tape, a floppy disk, an optical data storage device, etc.

Accordingly, the present disclosure further provides an apparatus for transmitting information. The apparatus includes:
one or more processors, and
a memory for storing processor-executable instructions, where
the one or more processors are configured to perform any one of the methods for transmitting information on an LMF side.

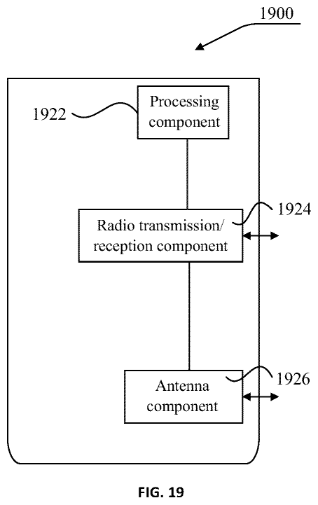

With reference to FIG. 19, FIG. 19 is a schematic structural diagram of an apparatus 1900 for transmitting information according to an example. The apparatus 1900 may be provided as an LMF. With reference to FIG. 19, the apparatus 1900 includes a processing component 1922, a radio transmission/reception component 1924, an antenna component 1926, and a signal processing portion specific to a radio interface. The processing component 1922 may further include at least one processor.

One processor in the processing component 1922 may be configured to perform any one of the methods for transmitting information on an LMF side.

In a first aspect, a method for transmitting information is provided in the embodiments of the present disclosure. The method is performed by a base station and includes:
transmitting indication information, where the indication information is used for indicating whether the base station supports reception of a first request message transmitted by a terminal, and the first request message is used for requesting the base station to activate or deactivate a preconfigured measurement gap.

Alternatively, the indication information is used for indicating at least one of the following:
the base station supports the terminal in transmitting the first request message;
the base station allows the terminal to transmit the first request message;
the base station does not support the terminal in transmitting the first request message; or
the base station does not allow the terminal to transmit the first request message.

Alternatively, the transmitting indication information includes:
transmitting the indication information to the terminal.

Alternatively, the transmitting the indication information to the terminal includes:
transmitting, in a case where the preconfigured measurement gap is configured for the terminal, the indication information to the terminal.

Alternatively, the method further includes:
receiving, in a case where the indication information indicates that the base station supports reception of the first request message transmitted by the terminal, the first request message transmitted by the terminal.

Alternatively, the transmitting indication information includes:
transmitting the indication information to a location management function (LMF).

Alternatively, the transmitting the indication information to the location management function (LMF) includes:
transmitting the indication information to the LMF via a first new radio positioning protocol A (NRPPa) message.

Alternatively, the method further includes:
transmitting a second request message to the LMF, where the second request message is used for requesting the LMF to transmit a third request message, and the third request message is used for requesting the base station to activate or deactivate the preconfigured measurement gap; and
receiving the third request message transmitted by the LMF based on the second request message.

Alternatively, the transmitting the second request message to the LMF includes:
transmitting the second request message to the LMF via a first NRPPa message.

Alternatively, the first NRPPa message is any one of the following:
a measurement preconfiguration confirm message;
a transmission and receiving point information response (TRP information response) message; or
other NRPPa messages.

Alternatively, the method further includes:
receiving a fourth request message transmitted by the LMF, where the fourth request message is used for requesting the base station to transmit the indication information.

Alternatively, the receiving the fourth request message transmitted by the LMF includes:
receiving the fourth request message transmitted by the LMF via a second NRPPa message.

Alternatively, the second NRPPa message is any one of the following:
a measurement preconfiguration required message;
a transmission and receiving point information request (TRP information request) message; or
other NRPPa messages.

Alternatively, the preconfigured measurement gap is at least used for the terminal to perform positioning-related measurement.

In a second aspect, a method for transmitting information is provided in the embodiments of the present disclosure. The method is performed by a terminal and includes:
receiving indication information transmitted by a base station, where the indication information is used for indicating whether the base station supports reception of a first request message transmitted by the terminal, and the first request message is used for requesting the base station to activate or deactivate a preconfigured measurement gap.

Alternatively, the receiving indication information transmitted by the base station includes:
receiving the indication information transmitted to the terminal by the base station in a case where the base station configures the preconfigured measurement gap for the terminal.

Alternatively, the method further includes:
transmitting the first request message to the base station in a case where the indication information indicates that the base station supports reception of the first request message transmitted by the terminal.

Alternatively, the indication information is used for indicating any one of the following:
the base station supports the terminal in transmitting the first request message;
the base station allows the terminal to transmit the first request message;
the base station does not support the terminal in transmitting the first request message; or
the base station does not allow the terminal to transmit the first request message.

Alternatively, the measurement gap is at least used for the terminal to perform positioning-related measurement.

In a third aspect, a method for transmitting information is provided in the embodiments of the present disclosure. The method is performed by a location management function (LMF) and includes:
receiving indication information transmitted by a base station, where the indication information is used for indicating whether the base station supports reception of a first request message transmitted by a terminal, and the first request message is used for requesting the base station to activate or deactivate a preconfigured measurement gap.

Alternatively, the receiving indication information transmitted by the base station includes:
receiving the indication information transmitted by the base station via a first new radio positioning protocol A (NRPPa) message.

Alternatively, the method further includes:
receiving a second request message transmitted by the base station, where the second request message is used for requesting the LMF to transmit a third request message, and the third request message is used for requesting the base station to activate or deactivate the preconfigured measurement gap; and
transmitting the third request message to the base station based on the second request message.

Alternatively, the receiving the second request message transmitted by the base station includes:
receiving the second request message transmitted by the base station via a first NRPPa message.

Alternatively, the first NRPPa message is any one of the following:
a measurement preconfiguration confirm message;
a transmission and receiving point information response (TRP information response) message; or
other NRPPa messages.

Alternatively, the method further includes:
transmitting a fourth request message to the base station, where the fourth request message is used for requesting the base station to transmit the indication information.

Alternatively, the transmitting the fourth request message to the base station includes:
transmitting the fourth request message to the base station via a second NRPPa message.

Alternatively, the second NRPPa message is any one of the following:
a measurement preconfiguration required message;
a transmission and receiving point information request (TRP information request) message; or
other NRPPa messages.

Alternatively, the measurement gap is at least used for the terminal to perform positioning-related measurement.

The technical solutions according to the embodiments of the present disclosure can have the beneficial effects as follows:

In the embodiments of the present disclosure, the indication information may be transmitted by the base station. The indication information is used for indicating whether the base station supports reception of the first request message transmitted by the terminal. The first request message is used for requesting the base station to activate or deactivate the preconfigured measurement gap, that is, the base station may inform an opposite device of whether the base station supports the terminal in activating or deactivating the preconfigured measurement gap. The activation or deactivation of a preconfigured measurement gap may be guaranteed, accuracy and reliability of terminal positioning are improved, and a location delay is reduced.

Other implementation solutions of the present disclosure will readily occur to those skilled in the art upon consideration of the description and practice of the present disclosure. The present disclosure is intended to cover any variations, uses, or adaptive changes of the present disclosure that follow the general principles of the present disclosure and include common general knowledge or customary technical means in the art not disclosed in the present disclosure. The description and the embodiments are merely deemed illustrative, and the true scope and spirit of the present disclosure are indicated by the following claims.

It should be understood that the present disclosure is not limited to the precise structure that has been described above and shown in the accompanying drawings, and that various modifications and changes may be made without departing from its scope. The scope of the present disclosure is limited merely by the appended claims.

1. A method for transmitting information, performed by a base station, comprising:
transmitting indication information, wherein the indication information is used for indicating whether the base station supports reception of a first request message transmitted by a terminal, and the first request message is used for requesting the base station to activate or deactivate a preconfigured measurement gap.

2. The method according to claim 1, wherein the indication information is used for indicating at least one of:
the base station supports the terminal in transmitting the first request message;
the base station allows the terminal to transmit the first request message;
the base station does not support the terminal in transmitting the first request message; or
the base station does not allow the terminal to transmit the first request message.

3. The method according to claim 1, wherein the transmitting indication information comprises:
transmitting the indication information to the terminal.

4. The method according to claim 3, wherein the transmitting the indication information to the terminal comprises:
transmitting, in a case where the base station configures the preconfigured measurement gap for the terminal, the indication information to the terminal.

5. The method according to claim 3, further comprising:
receiving, in a case where the indication information indicates that the base station supports reception of the first request message transmitted by the terminal, the first request message transmitted by the terminal.

6. The method according to claim 1, wherein the transmitting indication information comprises:
transmitting the indication information to a location management function (LMF).

7. The method according to claim 6, wherein the transmitting the indication information to the location management function (LMF) comprises:
transmitting the indication information to the LMF via a first new radio positioning protocol A (NRPPa) message;
wherein the first NRPPa message comprises any one of:
a measurement preconfiguration confirm message;
a transmission and receiving point information response (TRP information response) message; or
other NRPPa messages.

8. The method according to claim 6, further comprising:
transmitting a second request message to the LMF, wherein the second request message is used for requesting the LMF to transmit a third request message, and the third request message is used for requesting the base station to activate or deactivate the preconfigured measurement gap; and
receiving the third request message transmitted by the LMF based on the second request message.

9. The method according to claim 8, wherein the transmitting the second request message to the LMF comprises:
transmitting the second request message to the LMF via a first new radio positioning protocol A (NRPPa) message.

10. (canceled)

11. The method according to claim 6, further comprising:
receiving a fourth request message transmitted by the LMF, wherein the fourth request message is used for requesting the base station to transmit the indication information.

12. The method according to claim 11, wherein the receiving the fourth request message transmitted by the LMF comprises:
receiving the fourth request message transmitted by the LMF via a second new radio positioning protocol A (NRPPa) message;
wherein the second NRPPa message comprises any one of:
a measurement preconfiguration required message;
a transmission and receiving point information request (TRP information request) message; or
other NRPPa messages.

13. (canceled)

14. The method according to claim 1, wherein the preconfigured measurement gap is at least used for the terminal to perform positioning-related measurement.

15. A method for transmitting information, performed by a terminal, comprising:
receiving indication information transmitted by a base station, wherein the indication information is used for indicating whether the base station supports reception of a first request message transmitted by the terminal, and the first request message is used for requesting the base station to activate or deactivate a preconfigured measurement gap.

16. The method according to claim 15, wherein the receiving indication information transmitted by the base station comprises:
receiving the indication information transmitted to the terminal by the base station in a case where the base station configures the preconfigured measurement gap for the terminal.

17. The method according to claim 15, further comprising:
transmitting the first request message to the base station in a case where the indication information indicates that the base station supports reception of the first request message transmitted by the terminal.

18.-19. (canceled)

20. A method for transmitting information, performed by a location management function (LMF), comprising:
receiving indication information transmitted by a base station, wherein the indication information is used for indicating whether the base station supports reception of a first request message transmitted by a terminal, and the first request message is used for requesting the base station to activate or deactivate a preconfigured measurement gap.

21. The method according to claim 20, wherein the receiving indication information transmitted by the base station comprises:
receiving the indication information transmitted by the base station via a first new radio positioning protocol A (NRPPa) message;
wherein the first NRPPa message comprises any one of:
a measurement preconfiguration confirm message;
a transmission and receiving point information response (TRP information response) message; or
other NRPPa messages.

22.-34. (canceled)

35. An apparatus for transmitting information, comprising:
one or more processors, and
a memory for storing processor-executable instructions, wherein
the one or more processors are configured to perform the method for transmitting information according to claim 1.

36. An apparatus for transmitting information, comprising:
one or more processors, and
a memory for storing processor-executable instructions, wherein
the one or more processors are configured to perform the method for transmitting information according to claim 15.

37. An apparatus for transmitting information, comprising:
one or more processors, and
a memory for storing processor-executable instructions, wherein
the one or more processors are configured to perform the method for transmitting information according to claim 20.
